(19) United States
(12) Patent Application Publication
(10) Pub. No.: US 2024/0204839 A1
(43) Pub. Date: Jun. 20, 2024

(54) BEAMFORMING REPORT FEEDBACK METHOD AND APPARATUS

(71) Applicant: HUAWEI TECHNOLOGIES CO., LTD., Shenzhen (CN)

(72) Inventors: Chenchen LIU, Shenzhen (CN); Jian YU, Shenzhen (CN); Ming GAN, Shenzhen (CN)

(21) Appl. No.: 18/589,665

(22) Filed: Feb. 28, 2024

Related U.S. Application Data
(63) Continuation of application No. PCT/CN2022/111876, filed on Aug. 11, 2022.

(30) Foreign Application Priority Data
Aug. 31, 2021 (CN) 202111015546.0

(51) Int. Cl. H04B 7/06; H04L 5/00

(52) U.S. Cl. CPC H04B 7/0617; H04L 5/0044; H04L 5/0094

(57) ABSTRACT

This application discloses a beamforming report feedback method and an apparatus. The method includes: A first communication apparatus sends a trigger frame to a second communication apparatus; the second communication apparatus feeds back a beamforming report frame to the first communication apparatus after receiving the trigger frame. The trigger frame includes first information, the first information indicates the second communication apparatus to feed back at least one segment of a beamforming report. In addition, the beamforming report frame includes a first segment, the first segment indicates channel information on at least two subcarriers, a space between locations of indexes of any two of the at least two subcarriers in indexes of reference subcarriers is a multiple of N, and Nis an integer greater than or equal to 2. According to the method provided in this application, signaling overheads of the beamforming report can be effectively reduced.

### CROSS-REFERENCE TO RELATED APPLICATIONS

This application is a continuation of International Application No. PCT/CN2022/111876, filed on Aug. 11, 2022, which claims priority to Chinese Patent Application No. 202111015546.0, filed on Aug. 31, 2021. The disclosures of the aforementioned applications are hereby incorporated by reference in their entireties.

### TECHNICAL FIELD

This application relates to the field of communication technologies, and in particular, to a beamforming report feedback method and an apparatus.

### BACKGROUND

Generally, a beamforming transmit end (beamformer) may obtain a beamforming matrix based on channel information fed back in a beamforming report, and adjust an amplitude and/or a phase of a transmit signal of each radio frequency link based on the beamforming matrix, to improve link performance. For example, a beamformee (beamformee) may obtain, based on a null data packet announcement (null data packet announcement, NDPA) frame sent by the beamformer, an index of a subcarrier of which the channel information needs to be fed back, and obtain a channel measurement result of the subcarrier based on an NDP frame sent by the beamformer, to feed back the channel information of the subcarrier by using the beamforming report.

However, as system bandwidth continuously increases, a quantity of subcarriers that need to be fed back in the beamforming report is increasing, and a length of the beamforming report is also increasing. When the beamforming report exceeds a specific quantity of bytes, the beamforming report needs to be segmented. In addition, to enable the beamformer to effectively obtain the beamforming matrix, the beamformee needs to feed back all segments of the beamforming report.

However, the foregoing method causes high signaling overheads of the beamforming report.

### SUMMARY

This application provides a beamforming report feedback method and an apparatus, so that signaling overheads of a beamforming report can be effectively reduced.

According to a first aspect, an embodiment of this application provides a beamforming report feedback method. The method includes:

A first communication apparatus sends a trigger frame to a second communication apparatus, where the trigger frame includes first information, the first information indicates the second communication apparatus to feed back at least one segment of a beamforming report, the at least one segment includes a first segment, and the beamforming report is used to report channel information between the first communication apparatus and the second communication apparatus. The first communication apparatus receives a beamforming report frame from the second communication apparatus, where the beamforming report frame includes the first segment, the first segment indicates channel information on at least two subcarriers, a space between locations of indexes of any two of the at least two subcarriers in indexes of reference subcarriers is a multiple of N, the reference subcarriers are obtained based on bandwidth information, partial bandwidth information, and grouping information, and N is an integer greater than or equal to 2.

In this embodiment of this application, that a space between locations of indexes of any two of the at least two subcarriers in indexes of reference subcarriers is a multiple of N may alternatively be understood as that a space between locations of indexes of neighboring subcarriers in the at least two subcarriers in the indexes of the reference subcarriers is N. For example, if the at least two subcarriers include a first subcarrier and a second subcarrier, a space between locations of an index of the first subcarrier and an index of the second subcarrier in the indexes of the reference subcarriers is a multiple of N. For example, if the location of the index of the first subcarrier in the indexes of the reference subcarriers is the 1^{st} location, and the location of the index of the second subcarrier in the indexes of the reference subcarriers is the 5^{th} location, the space between the locations of the index of the first subcarrier and the index of the second subcarrier in the indexes of the reference subcarriers is 4, or it may be understood as that a difference between the locations of the index of the first subcarrier and the index of the second subcarrier in the indexes of the reference subcarrier is three locations.

In this embodiment of this application, after the first communication apparatus obtains the at least one segment (for example, one segment, two segments, three segments, or four segments) of the beamforming report, because the space between the locations of the indexes, of the at least two subcarriers included in the at least one segment such as the first segment, that are in the indexes of the reference subcarriers is a multiple of N, that is, the at least two subcarriers included in the first segment may be distributed on the reference subcarriers, the first communication apparatus may equivalently obtain a channel measurement result corresponding to a quantity of groups (for example, Ng′) greater than that of the grouping information (for example, Ng). Therefore, even if the first communication apparatus receives a part of segments, the first communication apparatus can still equivalently obtain, based on the part of segments, the channel measurement result corresponding to quantity of groups, for example, Ng′. This improves a case in which all segments of the beamforming report need to be transmitted, and effectively reduces signaling overheads of the beamforming report frame.

In a possible implementation, the first information includes M bits, each of the M bits corresponds to a segment of the beamforming report, a value of each bit indicates whether to feed back the corresponding segment, and M is an integer greater than or equal to 2.

In a possible implementation, M=N.

In this case, a quantity of segments of the beamforming report is equal to N. Therefore, the reference subcarriers obtained based on the bandwidth information, the partial bandwidth information, and the grouping information may be evenly distributed in the segments.

Optionally, M is greater than N, or M is less than N. For example, when M is greater than N, it indicates that the quantity of segments of the beamforming report is greater than N, and it indicates that channel information of subcarriers fed back in a part of segments overlaps, that is, channel information of a part of subcarriers is allowed to be fed back in different segments. For another example, when M is less than N, it indicates that the quantity of segments of the beamforming report is less than N, and it indicates that M segments may be fed back, that is, channel information of a part of subcarriers is allowed not to be fed back in all segments. This is not limited in this embodiment of this application.

In a possible implementation, the indexes of the reference subcarriers in ascending order of frequencies are scidx(0), scidx(1), . . . , and scidx(Ns−1), where Ns is a total quantity of subcarriers included in the reference subcarriers, and Ns and the indexes of the reference subcarriers are obtained based on the bandwidth information, the partial bandwidth information, and the grouping information; and an index of an i^{th} subcarrier in the first segment is scidx(k+N×i), where k indicates that the first segment is a k^{th} segment of the beamforming report, k is an integer greater than or equal to 0, and i is an integer greater than or equal to 0.

For example, when k=0, the first segment is the 0^{th} segment of the beamforming report, and indexes of subcarriers in the first segment are sequentially scidx(0), scidx(N), scidx(2×N), and the like. To be specific, an index of the 0^{th} subcarrier in the first segment is the 0^{th} location in the indexes of the reference subcarriers, an index of the 1^{st} subcarrier in the first segment is an N^{th} location in the indexes of the reference subcarriers, and an index of the 2^{nd} subcarrier in the first segment is the 2^{nd} location in the indexes of the reference subcarriers. In other words, a space between locations of the index of the 0^{th} subcarrier and the index of the 1^{st} subcarrier in the indexes of the reference subcarriers is N (that is, N−0=N), a space between locations of the index of the 0^{th} subcarrier and the index of the 2^{nd} subcarrier in the indexes of the reference subcarriers is 2N (that is, 2N−0=2N), and a space between locations of the index of the 1^{st} subcarrier and the index of the 2^{nd} subcarrier in the indexes of the reference subcarriers is N (that is, 2N−N=N).

It may be understood that, when M=N, and the first information indicates to feed back N segments of the beamforming report, it is equivalent to that the second communication apparatus needs to feed back all segments of the beamforming report. In this case, the second communication apparatus may segment the beamforming report based on the method provided in this embodiment of this application. For example, the index of the i^{th} subcarrier in the first segment is scidx(k+N×i). Therefore, even if the first communication apparatus unsuccessfully receives all the segments, the first communication apparatus can still obtain a beamforming matrix, and the second communication apparatus does not need to retransmit the beamforming report or the like.

In a possible implementation, k is an integer greater than or equal to 0 and less than or equal to M−1.

In a possible implementation, N is a predefined integer, or N is negotiated by the first communication apparatus and the second communication apparatus, or N is notified by the first communication apparatus to the second communication apparatus.

In a possible implementation, M is a predefined integer, or M is negotiated by the first communication apparatus and the second communication apparatus, or M is notified by the first communication apparatus to the second communication apparatus.

In a possible implementation, the method further includes: The first communication apparatus generates a beamforming matrix (which may also be a beamforming adjustment coefficient, a beamforming weight matrix, or the like) based on the beamforming report frame, where the beamforming matrix is used to adjust an amplitude and/or a phase of a to-be-sent signal.

In a possible implementation, before that a first communication apparatus sends a trigger frame to a second communication apparatus, the method further includes:

The first communication apparatus sends a null data packet announcement NDPA frame to the second communication apparatus, where the NDPA frame includes the bandwidth information, the partial bandwidth information, and the grouping information, the bandwidth information indicates bandwidth of a channel measurement reference signal, the partial bandwidth information indicates a frequency segment in which the at least two subcarriers are located, and the grouping information indicates that channel information of one subcarrier in every Ng subcarriers is fed back. The first communication apparatus sends a null data packet NDP frame to the second communication apparatus, where the NDP frame is used for channel estimation.

According to a second aspect, an embodiment of this application provides a beamforming report feedback method. The method includes:

A second communication apparatus receives a trigger frame from a first communication apparatus, where the trigger frame includes first information, the first information indicates the second communication apparatus to feed back at least one segment of a beamforming report, the at least one segment includes a first segment, and the beamforming report is used to report channel information between the first communication apparatus and the second communication apparatus. The second communication apparatus sends a beamforming report frame to the first communication apparatus, where the beamforming report frame includes the first segment, the first segment indicates channel information on at least two subcarriers, a space between locations of indexes of any two of the at least two subcarriers in indexes of reference subcarriers is a multiple of N, the reference subcarriers are obtained based on bandwidth information, partial bandwidth information, and grouping information, and N is an integer greater than or equal to 2.

In a possible implementation, the first information includes M bits, each of the M bits corresponds to a segment of the beamforming report, a value of each bit indicates whether to feed back the corresponding segment, and M is an integer greater than or equal to 2.

In a possible implementation, the indexes of the reference subcarriers in ascending order of frequencies are scidx(0), scidx(1), . . . , and scidx(Ns−1), where Ns is a total quantity of subcarriers included in the reference subcarriers, and Ns and the indexes of the reference subcarriers are obtained based on the bandwidth information, the partial bandwidth information, and the grouping information; and an index of an i^{th} subcarrier in the first segment is scidx(k+N×i), where k indicates that the first segment is a k^{th} segment of the beamforming report, k is an integer greater than or equal to 0 and less than or equal to M−1, i is an integer greater than or equal to 0, and M is an integer greater than or equal to 2.

In a possible implementation, N is a predefined integer, or N is negotiated by the first communication apparatus and the second communication apparatus, or N is notified by the first communication apparatus to the second communication apparatus.

In a possible implementation, M is a predefined integer, or M is negotiated by the first communication apparatus and the second communication apparatus, or M is notified by the first communication apparatus to the second communication apparatus.

In a possible implementation, the beamforming report frame is used to determine a beamforming matrix, and the beamforming matrix is used to adjust an amplitude and/or a phase of a signal sent by the first communication apparatus.

In a possible implementation, before that a second communication apparatus receives a trigger frame from a first communication apparatus, the method further includes:

The second communication apparatus receives a null data packet announcement NDPA frame from the first communication apparatus, where the NDPA frame includes the bandwidth information, the partial bandwidth information, and the grouping information, the bandwidth information indicates bandwidth of a channel measurement reference signal, the partial bandwidth information indicates a frequency segment in which the at least two subcarriers are located, and the grouping information indicates that channel information of one subcarrier in every Ng subcarriers is fed back. The second communication apparatus receives a null data packet NDP frame from the first communication apparatus, where the NDP frame is used for channel estimation.

According to a third aspect, an embodiment of this application provides a communication apparatus, configured to perform the method according to any one of the first aspect or the possible implementations of the first aspect. The communication apparatus includes units configured to perform the method according to any one of the first aspect or the possible implementations of the first aspect.

According to a fourth aspect, an embodiment of this application provides a communication apparatus, configured to perform the method according to any one of the second aspect or the possible implementations of the second aspect. The communication apparatus includes units configured to perform the method according to any one of the second aspect or the possible implementations of the second aspect.

In the third aspect or the fourth aspect, the communication apparatus may include a transceiver unit and a processing unit. For specific descriptions of the transceiver unit and the processing unit, refer to apparatus embodiments shown below.

According to a fifth aspect, an embodiment of this application provides a communication apparatus. The communication apparatus includes a processor, configured to perform the method according to any one of the first aspect or the possible implementations of the first aspect. Alternatively, the processor is configured to execute a program stored in a memory. When the program is executed, the method according to any one of the first aspect or the possible implementations of the first aspect is performed.

For the foregoing communication apparatuses, in a process of performing the foregoing method, a process of sending information in the foregoing method may be understood as a process of outputting the foregoing information by the processor. When outputting the foregoing information, the processor outputs the foregoing information to a transceiver, so that the transceiver transmits the information. After the foregoing information is output by the processor, other processing may further need to be performed on the information before the information arrives at the transceiver. Similarly, when the processor receives the input information, the transceiver receives the foregoing information, and inputs the information into the processor. Further, after the transceiver receives the foregoing information, other processing may need to be performed on the foregoing information before the information is input into the processor.

Operations such as transmitting, sending, and receiving related to the processor may be more generally understood as operations such as outputting, receiving, and inputting of the processor unless otherwise specified or if the operations do not conflict with actual functions or internal logic of the operations in related descriptions, but not operations such as transmitting, sending, and receiving directly performed by a radio frequency circuit and an antenna.

In an implementation process, the processor may be a processor specially configured to perform these methods, or a processor, for example, a general-purpose processor, that executes computer instructions in a memory to perform these methods. The memory may be a non-transitory (non-transitory) memory, for example, a read-only memory (read-only memory, ROM). The memory and the processor may be integrated on a same chip, or may be separately disposed on different chips. A type of the memory and a manner of disposing the memory and the processor are not limited in this embodiment of this application. It may be understood that descriptions of the processor and the memory are also applicable to the sixth aspect shown below. For ease of description, details are not described again in the sixth aspect.

In a possible implementation, the memory is located outside the communication apparatus.

In a possible implementation, the memory is located inside the communication apparatus.

In this embodiment of this application, the processor and the memory may alternatively be integrated into one component. In other words, the processor and the memory may alternatively be integrated together.

In a possible implementation, the communication apparatus further includes a transceiver. The transceiver is configured to receive or send a signal.

According to a sixth aspect, an embodiment of this application provides a communication apparatus. The communication apparatus includes a processor, configured to perform the method according to any one of the second aspect or the possible implementations of the second aspect. Alternatively, the processor is configured to execute a program stored in a memory. When the program is executed, the method according to any one of the second aspect or the possible implementations of the second aspect is performed.

In a possible implementation, the memory is located outside the communication apparatus.

In a possible implementation, the memory is located inside the communication apparatus.

In this embodiment of this application, the processor and the memory may alternatively be integrated into one component. In other words, the processor and the memory may alternatively be integrated together.

In a possible implementation, the communication apparatus further includes a transceiver. The transceiver is configured to receive or send a signal.

According to a seventh aspect, an embodiment of this application provides a communication apparatus. The communication apparatus includes a logic circuit and an interface, the logic circuit is coupled to the interface, and the interface is configured to output a trigger frame and input a beamforming report frame.

Optionally, the logic circuit is further configured to generate a beamforming matrix based on the beamforming report frame. Optionally, the interface is further configured to input an NDPA frame, and the logic circuit is further configured to process the NDPA frame. Optionally, the interface is further configured to input an NDP frame, and the logic circuit is further configured to process the NDP frame.

For specific descriptions of the trigger frame, the beamforming report frame, the NDPA frame, the NDP frame, a segment of a beamforming report, an index of a reference subcarrier, or the like, refer to the first aspect, the second aspect, or the like. Details are not described herein again.

According to an eighth aspect, an embodiment of this application provides a communication apparatus. The communication apparatus includes a logic circuit and an interface, the logic circuit is coupled to the interface, and the interface is configured to input a trigger frame and output a beamforming report frame.

Optionally, the logic circuit is configured to generate the beamforming report frame and the like. Optionally, the interface is further configured to input an NDPA frame, and the logic circuit is further configured to process the NDPA frame. Optionally, the interface is further configured to input an NDP frame, and the logic circuit is further configured to process the NDP frame.

Optionally, the communication apparatus further includes a memory. The memory is configured to store a beamforming report frame segmentation method or the like.

For specific descriptions of the trigger frame, the beamforming report frame, the NDPA frame, the NDP frame, a segment of a beamforming report, an index of a reference subcarrier, or the like, refer to the first aspect, the second aspect, or the like. Details are not described herein again.

According to a ninth aspect, an embodiment of this application provides a computer-readable storage medium. The computer-readable storage medium is configured to store a computer program. When the computer program is run on a computer, the method according to any one of the first aspect or the possible implementations of the first aspect is performed.

According to a tenth aspect, an embodiment of this application provides a computer-readable storage medium. The computer-readable storage medium is configured to store a computer program. When the computer program is run on a computer, the method according to any one of the second aspect or the possible implementations of the second aspect is performed.

According to an eleventh aspect, an embodiment of this application provides a computer program product. The computer program product includes a computer program or computer code. When the computer program product runs on a computer, the method according to any one of the first aspect or the possible implementations of the first aspect is performed.

According to a twelfth aspect, an embodiment of this application provides a computer program product. The computer program product includes a computer program or computer code. When the computer program product runs on a computer, the method according to any one of the second aspect or the possible implementations of the second aspect is performed.

According to a thirteenth aspect, an embodiment of this application provides a computer program. When the computer program is run on a computer, the method according to any one of the first aspect or the possible implementations of the first aspect is performed.

According to a fourteenth aspect, an embodiment of this application provides a computer program. When the computer program is run on a computer, the method according to any one of the second aspect or the possible implementations of the second aspect is performed.

According to a fifteenth aspect, an embodiment of this application provides a wireless communication system. The wireless communication system includes a first communication apparatus and a second communication apparatus, the first communication apparatus is configured to perform the method according to any one of the first aspect or the possible implementations of the first aspect, and the second communication apparatus is configured to perform the method according to any one of the second aspect or the possible implementations of the second aspect.

### BRIEF DESCRIPTION OF DRAWINGS

FIG. 1 is a schematic diagram of structures of an access point and a station according to an embodiment of this application;

FIG. 2a is a schematic diagram of an architecture of a communication system according to an embodiment of this application;

FIG. 2b is a schematic diagram of an architecture of another communication system according to an embodiment of this application;

FIG. 2c is a schematic diagram of an architecture of still another communication system according to an embodiment of this application;

FIG. 3 is a schematic diagram of a scenario of a beamforming report feedback method according to an embodiment of this application;

FIG. 4 is a schematic interaction diagram of a beamforming report feedback method according to an embodiment of this application;

FIG. 5 is a schematic diagram of a beamforming multiple-input multiple-output (multiple in and multiple out, MIMO) system according to an embodiment of this application;

FIG. 6a is a schematic diagram of a scenario of another beamforming report feedback method according to an embodiment of this application;

FIG. 6b is a schematic diagram of a scenario of still another beamforming report feedback method according to an embodiment of this application;

FIG. 7 is a schematic interaction diagram of a beamforming report feedback method according to an embodiment of this application; and

FIG. 8 to FIG. 10 are schematic diagrams of structures of communication apparatuses according to embodiments of this application.

### DESCRIPTION OF EMBODIMENTS

To make objectives, technical solutions, and advantages of this application clearer, the following further describes this application with reference to the accompanying drawings.

In the specification, claims, and the accompanying drawings of this application, terms such as “first” and “second” are only intended to distinguish between different objects but do not describe a particular order. In addition, terms “include”, “have”, or any other variant thereof are intended to cover a non-exclusive inclusion. For example, a process, a method, a system, a product, or a device that includes a series of steps or units is not limited to the listed steps or units, but optionally further includes an unlisted step or unit, or optionally further includes another step or unit inherent to the process, the method, the product, or the device.

An “embodiment” mentioned in this specification means that a particular feature, structure, or characteristic described with reference to this embodiment may be included in at least one embodiment of this application. The phrase shown in various locations in this specification may not necessarily refer to a same embodiment, and is not an independent or optional embodiment exclusive from another embodiment. It is explicitly and implicitly understood by a person skilled in the art that embodiments described in the specification may be combined with another embodiment.

In this application, “at least one (item)” means one or more, “a plurality of” means two or more, “at least two (items)” means two, three, or more, and “and/or” is used to describe an association relationship between associated objects and indicates that three relationships may exist. For example, “A and/or B” may indicate the following three cases: Only A exists, only B exists, and both A and B exist, where A and B may be singular or plural. The character “/” usually indicates an “or” relationship between the associated objects. “At least one of the following items (pieces)” or a similar expression thereof means any combination of these items. For example, at least one (piece) of a, b, or c may represent: a, b, c, a and b, a and c, b and c, or a, b, and c.

A method provided in this application may be applied to various communication systems, for example, an internet of things (internet of things, IOT) system, a narrow band internet of things (narrow band internet of things, NB-IOT) system, a long term evolution (long term evolution, LTE) system, a 5^{th} generation (5^{th} generation, 5G) communication system, and a new communication system (for example, 6G) emerging in future communication development. The method provided in this application may be further applied to a wireless local area network (wireless local area network, WLAN) system, for example, Wi-Fi.

The method provided in this application may be implemented by a communication apparatus in a wireless communication system. For example, the communication apparatus may be an access point (access point, AP) or a station (station, STA).

The access point is an apparatus having a wireless communication function, supports communication or perception by using a WLAN protocol, has a function of communicating with another device (for example, a station or another access point) in a WLAN network, and certainly may further have a function of communicating or perceiving with another device. Alternatively, the access point is equivalent to a bridge that connects a wired network and a wireless network. A main function of the access point is to connect various wireless network clients together and then connect the wireless network to the Ethernet. In the WLAN system, the access point may be referred to as an access point station (AP STA). The apparatus having a wireless communication function may be an entire device, or may be a chip or a processing system installed in an entire device. The device in which the chip or the processing system is installed may implement a method and a function in embodiments of this application under control of the chip or the processing system. The AP in embodiments of this application is an apparatus that provides a service for a STA, and may support the 802.11 series protocols. For example, the access point may be an access point for a terminal (for example, a mobile phone) to access a wired (or wireless) network, and is mainly deployed in a home, a building, and a park. A typical coverage radius is tens of meters to 100-odd meters. It is clear that the access point may alternatively be deployed outdoors. For another example, the AP may be a communication entity, for example, a communication server, a router, a switch, or a bridge, or the AP may include various forms of macro base stations, micro base stations, relay stations, and the like. It is clear that the AP may alternatively be a chip or a processing system in these devices in various forms, to implement the method and function in embodiments of this application. The access point in this application may be a high-efficient (high-efficient, HE) AP or an extremely high throughput (extremely high throughput, EHT) AP, or may be an access point or the like applicable to a future Wi-Fi standard.

The station is an apparatus having a wireless communication function, supports communication or perception by using a WLAN protocol, and has a capability of communicating with or perceiving another station or an access point in a WLAN network. In the WLAN system, the station may be referred to as a non-access point station (non-access point station, non-AP STA). For example, the STA is any user communication device that allows a user to communicate with or perceive an AP and further communicate with a WLAN. The apparatus having a wireless communication function may be an entire device, or may be a chip or a processing system installed in an entire device. The device in which the chip or the processing system is installed may implement a method and a function in embodiments of this application under control of the chip or the processing system. For example, the station may be a wireless communication chip, a wireless sensor, a wireless communication terminal, or the like, and may also be referred to as a user. For another example, the station may be a mobile phone supporting a Wi-Fi communication function, a tablet computer supporting a Wi-Fi communication function, a set-top box supporting a Wi-Fi communication function, a smart television supporting a Wi-Fi communication function, an intelligent wearable device supporting a Wi-Fi communication function, a vehicle-mounted communication device supporting a Wi-Fi communication function, a computer supporting a Wi-Fi communication function, and the like.

The WLAN system may provide high-speed and low-latency transmission. As a WLAN application scenario continuously evolves, a WLAN system is to be applied to more scenarios or industries, for example, applied to an internet of things industry, applied to an internet of vehicles industry or a banking industry, or applied to an enterprise office, an exhibition hall of a stadium, a concert hall, a hotel room, a dormitory, a ward, a classroom, a supermarket, a square, a street, a production workshop, a warehouse, and the like. Certainly, a device (for example, an access point or a station) supporting WLAN communication or perception may be a sensor node (for example, a smart water meter, a smart meter, or a smart air detection node) in a smart city, a smart device (for example, a smart camera, a projector, a display, a television, a speaker, a refrigerator, or a washing machine) in a smart home, a node in an internet of things, an entertainment terminal (for example, a wearable device such as an AR device or a VR device), a smart device (for example, a printer, a projector, a loudspeaker, or a speaker) in a smart office, an internet of vehicles device in an internet of vehicles, and infrastructure (for example, a vending machine, a self-service navigation station in a supermarket, a self-service cash collection device, or a self-service ordering machine) in a daily life scenario, a large-scale stadium, a music venue, and the like. For example, the access point and the station may be devices applied to the internet of vehicles, internet of things nodes, sensors, and the like in the internet of things (IOT, internet of things), smart cameras, smart remote controls, and smart water meters in a smart home, sensors in a smart city, and the like. Specific forms of the STA and the AP are not limited in embodiments of this application, and are merely examples for description herein.

Although this application is mainly described by using a network in which IEEE 802.11 is deployed as an example, a person skilled in the art easily understands that various aspects of this application may be expanded to other networks that use various standards or protocols, for example, Bluetooth (Bluetooth), a high performance radio LAN (high performance radio LAN, HIPERLAN) (which is a wireless standard that is similar to the IEEE 802.11 standard, and is mainly used in Europe), a wide area network (WAN), a wireless local area network (wireless local area network, WLAN), a personal area network (personal area network, PAN), or another known or later developed network.

For example, FIG. 1 is a schematic diagram of structures of an access point and a station according to an embodiment of this application. The AP may have a plurality of antennas, or may have a single antenna. As shown in FIG. 1, the AP includes a physical layer (physical layer, PHY) processing circuit and a media access control (media access control, MAC) processing circuit. The physical layer processing circuit may be configured to process a physical layer signal, and the MAC layer processing circuit may be configured to process a MAC layer signal. The 802.11 standard focuses on the PHY and the MAC. As shown in FIG. 1, FIG. 1 further shows a schematic diagram of a structure of a STA having a single antenna. In an actual scenario, the STA may alternatively have a plurality of antennas, and may be a device having more than two antennas. The STA may include a PHY processing circuit and a MAC processing circuit. The physical layer processing circuit may be configured to process a physical layer signal, and the MAC layer processing circuit may be configured to process a MAC layer signal.

In this application, a first communication apparatus may be an access point device or a station device, and a second communication apparatus may also be an access point device or a station device. For example, the first communication apparatus may be the access point device, and the second communication apparatus is the access point device. For another example, the first communication apparatus is the station device, and the second communication apparatus is the station device. For another example, the first communication apparatus may be the access point device, and the second communication apparatus is the station device. For another example, the first communication apparatus may be the station device, and the second communication apparatus is the access point device. It may be understood that the first communication apparatus and the second communication apparatus may also be collectively referred to as communication apparatuses. It may be understood that the first communication apparatus shown in this application may alternatively be understood as an apparatus for sending data through beamforming, or a beamforming transmit apparatus (a beamforming transmit end, or the like), for example, referred to as a beamformer. The second communication apparatus may alternatively be understood as an apparatus for receiving data, a beamforming feedback apparatus (namely, an apparatus for feeding back a beamforming report), or a beamforming receive apparatus (a beamforming receive end, or the like), for example, referred to as a beamformee.

With reference to the AP and the STA shown above, the following describes in detail a communication system in this application.

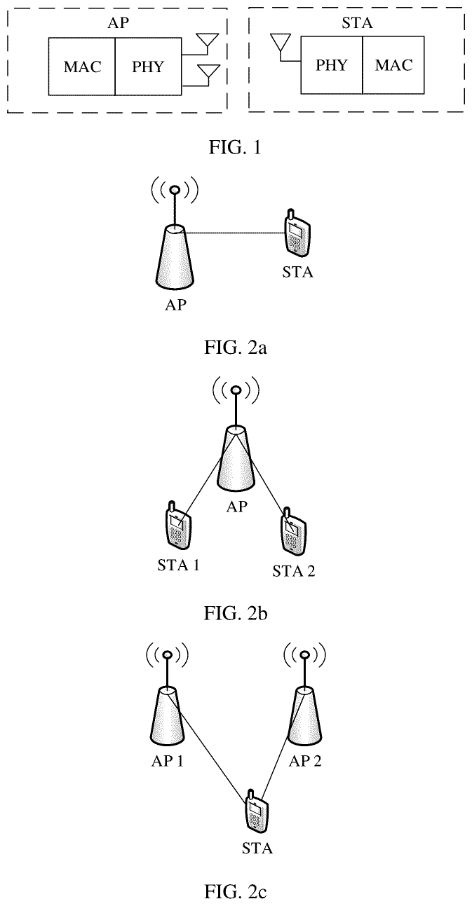

Optionally, the method provided in this application may be applied to a scenario in which a communication apparatus needs to obtain channel state information (channel state information, CSI) or beamforming matrix information between the communication apparatus and another communication apparatus. For example, FIG. 2a is a schematic diagram of an architecture of a communication system according to an embodiment of this application. The communication system includes at least one AP and at least one STA. FIG. 2a shows only an example of one AP and one STA. For example, the AP may send a trigger frame to the STA, so that the STA may send a beamforming report frame to the AP based on the trigger frame. For another example, the STA sends a trigger frame to the AP, so that the AP sends a beamforming report frame to the STA based on the trigger frame. It may be understood that for specific descriptions of the beamforming report frame, refer to the following descriptions. Details are not described herein.

Optionally, the method provided in this application may be applied to a scenario in which one communication apparatus needs to obtain CSI or beamforming matrix information between the communication apparatus and at least two communication apparatuses. For example, FIG. 2b is a schematic diagram of an architecture of another communication system according to an embodiment of this application. The communication system includes at least one AP and at least two STAs. FIG. 2b shows an example of one AP and two STAs, for example, a STA 1 and a STA 2. For example, the AP may send a trigger frame to each of the STA 1 and the STA 2, so that the STA 1 and the STA 2 each send a beamforming report frame to the AP based on the trigger frame. For example, by measuring channel state information between the AP and the STA 1 and channel state information between the AP and the STA 2, the AP may communicate with a STA (for example, the STA 1) in a good channel state. For another example, the AP may further adjust an amplitude and/or a phase of a transmit signal based on beamforming matrix information between the AP and the STA 1. For example, FIG. 2c is a schematic diagram of an architecture of still another communication system according to an embodiment of this application. The communication system includes at least two APs and at least one STA. FIG. 2c shows an example of two APs, for example, an AP 1 and an AP 2, and one STA. For example, the STA may send a trigger frame to each of the AP 1 and the AP 2, so that the AP 1 and the AP 2 each may send a beamforming report frame to the STA based on the trigger frame. For example, after the STA obtains channel state information between the STA and the AP 1 and channel state information between the STA and the AP 2, the STA may perform multi-point coordination with the AP 1 and the AP 2. It may be understood that for specific descriptions of the beamforming report frame, refer to the following descriptions. Details are not described herein.

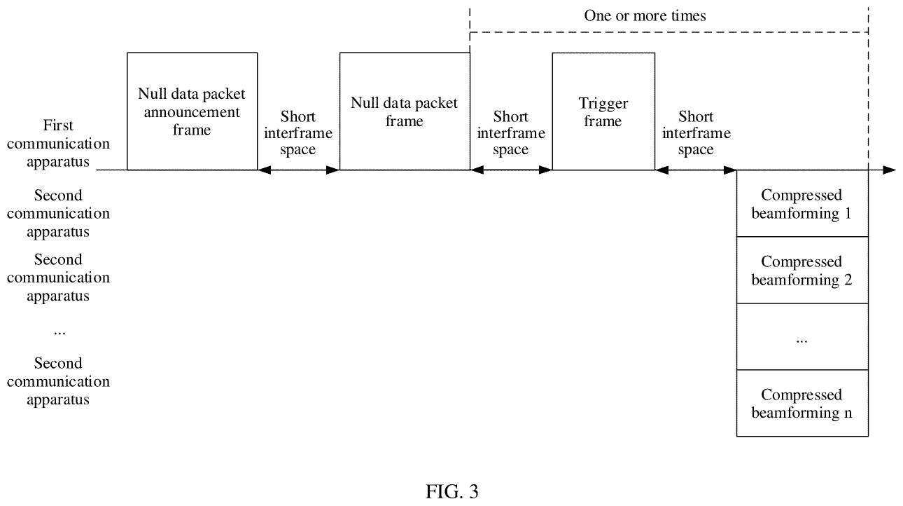

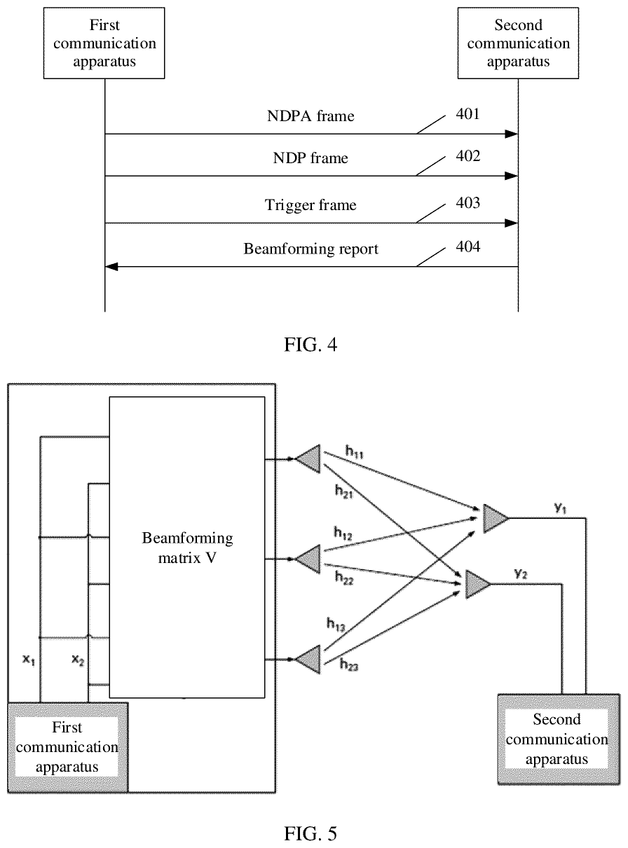

FIG. 3 is a schematic diagram of a scenario of a beamforming report feedback method according to an embodiment of this application. FIG. 4 is a schematic interaction diagram of a beamforming report feedback method according to an embodiment of this application. The following describes in detail the method in this application with reference to FIG. 3 and FIG. 4. As shown in FIG. 4, the method includes the following steps.
401: A first communication apparatus sends a null data packet announcement (null data packet announcement, NDPA) frame to a second communication apparatus, and correspondingly the second communication apparatus receives the NDPA frame.

The NDPA frame includes bandwidth information, partial bandwidth information, and grouping information. The bandwidth information indicates bandwidth of a channel measurement signal such as a null data packet (null data packet, NDP) frame. The partial bandwidth information indicates a frequency segment in which a subcarrier on which a beamforming report needs to be fed back in the bandwidth is located. The grouping information may also be referred to as a quantity of groups (number of grouping, Ng), the quantity of groups indicates that Ng subcarriers are grouped into one group, beamforming report information (such as CSI, a beamforming matrix, or a CQI) of only one subcarrier in the group of subcarriers needs to be fed back. Because a difference between channel state information of adjacent subcarriers is small, channel state information of one of the Ng subcarriers may be fed back. Because a beamforming matrix is obtained based on channel state information, a beamforming matrix of one of the Ng subcarriers may also be fed back. In other words, channel state information or a beamforming matrix of another subcarrier in the Ng subcarriers except the fed-back subcarrier may be obtained based on the fed-back subcarrier.
402: The first communication apparatus sends the NDP frame to the second communication apparatus, and correspondingly the second communication apparatus receives the NDP frame.

For example, as shown in FIG. 3, after the first communication apparatus sends the NDPA frame at a short interframe space (short interframe space, SIFS), the first communication apparatus may send the NDP frame to the second communication apparatus. It may be understood that the NDP frame may not include a data field part.

After obtaining the NDP frame, the second communication apparatus may perform channel estimation based on the NDP frame. That is, the NDP frame may be used for channel estimation. Therefore, the second communication apparatus obtains the channel state information. Alternatively, the channel state information may also be referred to as a channel measurement result, or the like. Optionally, before feeding back a beamforming report frame, the second communication apparatus may calculate a beamforming matrix based on the channel measurement result, and feed back information about the beamforming matrix (which may also be beamforming matrix information for short) to the first communication apparatus.
403: The first communication apparatus sends a trigger frame to the second communication apparatus, and correspondingly the second communication apparatus receives the trigger frame.

The trigger frame shown in this embodiment of this application may include a trigger frame, or may include a triggering frame having a trigger function. For example, as shown in FIG. 3, after the first communication apparatus sends the NDP frame at a short interframe space, the first communication apparatus may send the trigger frame to the second communication apparatus. The trigger frame may be used to trigger the second communication apparatus to feed back the beamforming report to the first communication apparatus. It may be understood that the trigger frame shown in this embodiment of this application may alternatively be a frame that carries a trigger instruction, for example, a beamforming feedback report trigger frame (beamforming feedback report poll, BFRP). The beamforming report may also be referred to as a beamforming feedback report or the like. This is not limited in this embodiment of this application. Similarly, the beamforming report frame shown below may also be referred to as a beamforming feedback report frame or the like. This is not limited in this embodiment of this application.
404: The second communication apparatus sends the beamforming report frame to the first communication apparatus, and correspondingly the first communication apparatus receives the beamforming report frame.

The first communication apparatus may obtain the beamforming matrix based on the beamforming report frame. The beamforming beam may be used to adjust an amplitude and/or a phase (which may also be a weight for short) of a transmit signal of each radio frequency link, to improve link performance.

Descriptions of beamforming (beamforming) (which is also referred to as beamforming) may be shown as follows:

For example, FIG. 5 is a schematic diagram of a beamforming multiple-input multiple-output (multiple in and multiple out, MIMO) system according to an embodiment of this application. As shown in FIG. 5, the first communication apparatus may send a signal x₁ and a signal x₂ on different time domain resources (for example, on different orthogonal frequency division multiplexing (orthogonal frequency division multiplexing, OFDM) symbols) by using a same frequency domain resource (for example, on a same subcarrier). After the signal x₁ and the signal x₂ are adjusted by using the beamforming matrix, energy of the signal x₁ may be concentrated in one direction for transmission, and energy of the signal x₂ may be concentrated in one direction for transmission. Therefore, signal energy may be enhanced, link transmission performance may be effectively improved, and receiving performance of the second communication apparatus may be improved.

For example, the signal Y_{N}_{_{RX}} received by the second communication apparatus may meet the following relationship:

$${Y}_{{N}_{RX}} = \sqrt{ρ / {N}_{TX}} \times {H}_{{N}_{RX} \times {N}_{TX}} {V}_{{N}_{TX} \times {N}_{SS}} {X}_{{N}_{SS}} + {Z}_{{N}_{RX}}$$

N_{RX} represents a quantity of receive antennas, N_{TX} represents a quantity of transmit antennas, and Nss represents a quantity of space-time streams. X_{Nss} represents a transmitted data vector, a length is equal to the quantity of space-time streams, V_{N}_{_{TX}}_{×N}_{_{SS}} Represents a beamforming matrix used when the first communication apparatus transmits a signal, Y_{N}_{_{RX}} represents a signal received by the second communication apparatus, H_{N}_{_{RX}}_{×N}_{_{TX}} represents a channel matrix, and Z_{N}_{_{RX}} represents noise. It may be understood that the beamforming MIMO system shown in FIG. 5 is merely an example (where the system shown in FIG. 5 is shown by using a single subcarrier as an example). The methods provided in embodiments of this application may be applied to the method shown in FIG. 5, and may also be applied to a system, for example, a system including a plurality of subcarriers. This is not limited in this application.

Generally, the beamforming matrix is obtained through a singular value decomposition (singular value decomposition, SVD) based on the channel matrix. For example, information about the beamforming matrix may be included in the beamforming report frame.

A singular value decomposition (singular value decomposition, SVD) is an important matrix decomposition in linear algebra. It is assumed that H is an (m×n)-order matrix, where all elements in H belong to a real number field or a complex number field. In this case, there is one decomposition that enables H=UΣV^{H}, where U is an m×m orthogonal matrix (that is, UU^{H}=I), V is an n×n orthogonal matrix, V^{H} a conjugate transpose matrix of V, and Σ is an m×n nonnegative real number diagonal matrix.

Generally, if the second communication apparatus directly feeds back the beamforming matrix (for example, represented by V), a plurality of bits are required to quantize a real part and an imaginary part of a complex number in the beamforming matrix. Therefore, to reduce an amount of feedback information, the 802.11 standard supports a feedback of a compressed beamforming matrix feedback report (for example, which is referred to as a compressed beamforming report), and the beamforming matrix is decomposed into a series of angle values through a Givins rotation (givens rotation) decomposition. As shown in Table 1, Table 1 shows angle information that needs to be fed back for beamforming matrices of different sizes. After being quantized into a specified quantity of bits, the angle information is fed back to the first communication apparatus. Therefore, the first communication apparatus restores the beamforming matrix based on the angle information, so that an amplitude and/or a phase of a transmit signal may be adjusted based on the beamforming matrix when the signal is sent.

TABLE 1

| Size of the | Quantity of angles | Angles |
|---|---|---|
| beamforming matrix | (number of angles) | (angles) |
| 2 × 1 | 2 | Ø_{1, 1} and φ_{2, 1} |
| 2 × 2 | 2 | Ø_{1, 1} and φ_{2, 1} |
| 3 × 1 | 4 | Ø_{1, 1}, Ø_{2, 1}, φ_{2, 1}, and φ_{3, 1} |
| 3 × 2 | 6 | Ø_{1, 1}, Ø_{2, 1}, φ_{2, 1}, φ_{3, 1}, Ø_{2, 2}, and φ_{3, 2} |
| 3 × 3 | 6 | Ø_{1, 1}, Ø_{2, 1}, φ_{2, 1}, φ_{3, 1}, Ø_{2, 2}, and φ_{3, 2} |
| 4 × 1 | 6 | Ø_{1, 1}, Ø_{2, 1}, Ø_{3, 1}, φ_{2, 1}, φ_{3, 1}, and φ_{4, 1} |
| 4 × 2 | 10 | Ø_{1, 1}, Ø_{2, 1}, Ø_{3, 1}, φ_{2, 1}, φ_{3, 1}, φ_{4, 1}, Ø_{2, 2}, |
| | | Ø_{3, 2}, φ_{3, 2}, and φ_{4, 2} |
| 4 × 3 | 12 | Ø_{1, 1}, Ø_{2, 1}, Ø_{3, 1}, φ_{2, 1}, φ_{3, 1}, φ_{4, 1}, Ø_{2, 2}, |
| | | Ø_{3, 2}, φ_{3, 2}, φ_{4, 2}, Ø_{3, 3}, and φ_{4, 3} |
| 4 × 4 | 12 | Ø_{1, 1}, Ø_{2, 1}, Ø_{3, 1}, φ_{2, 1}, φ_{3, 1}, φ_{4, 1}, Ø_{2, 2}, |
| | | Ø_{3, 2}, φ_{3, 2}, φ_{4, 2}, Ø_{3, 3}, and φ_{4, 3} |

The size of the beamforming matrix shown in Table 1 may be determined based on a quantity of transmit antennas (for example, the quantity of transmit antennas used when the first communication apparatus transmits the signal) and a quantity of space-time streams. The quantity of angles is determined based on the size of the beamforming matrix. For a conversion relationship between the beamforming matrix and the angle information, refer to a Givins rotation method. Details are not described in this application. It may be understood that when the beamforming matrix is decomposed into the angle information through Givins rotation, to feed back the angle information in the beamforming report, the beamforming report shown in this application may also be referred to as a compressed beamforming report.

For example, the compressed beamforming (compressed beamforming) report may be shown in Table 2.

TABLE 2

| Field (field) | Size (size)/bits | Meaning (meaning) |
|---|---|---|
| Average signal-to-noise ratio | 8 | Signal-to-noise ratio at a |
| of space-time stream 1 | | beamformee for space-time |
| (average SNR of space-time 1) | | stream 1 averaged over all data |
| | | subcarriers (signal-to-noise |
| | | ratio at a beamformee for |
| | | space-time stream 1 averaged |
| | | over all data subcarriers) |
| . . . | . . . | . . . |
| Average signal-to-noise ratio | 8 | Signal-to-noise ratio at the |
| of space-time stream Nc | | beamformee for the space-time |
| (average SNR of space-time | | stream Nc averaged over all |
| Nc) | | data subcarriers |
| Compressed beamforming | Na × (b_{Ø} + b_{φ})/2 | . . . |
| feedback matrix V for an index | | |
| k = scidx(0) of a subcarrier | | |
| (compressed beamforming | | |
| feedback matrix V for an index | | |
| k = scidx(0) of a subcarrier) | | |
| Compressed beamforming | Na × (b_{Ø} + b_{φ})/2 | . . . |
| feedback matrix V for an index | | |
| k = scidx(1) of a subcarrier | | |
| Compressed beamforming | Na × (b_{Ø} + b_{φ})/2 | . . . |
| feedback matrix V for an index | | |
| k = scidx(2) of a subcarrier | | |
| . . . | . . . | . . . |
| Compressed beamforming | Na × (b_{Ø} + b_{φ})/2 | . . . |
| feedback matrix V for an index | | |
| k = scidx(Ns − 1) of a subcarrier | | |

The first column represents an index of a reference subcarrier (which may be a reference subcarrier index for short), and the beamforming feedback matrix shown above is the beamforming matrix shown in this application. The second column represents a quantity of bits corresponding to content indicated by the first column. For example, when the quantity of bits is 8, it indicates that the signal-to-noise ratio of the corresponding space-time stream may be quantized by using eight bits. A quantity of columns (number of columns, Nc) shown in Table 2 may be equal to a quantity of space-time streams (for example, Nss), or may represent a quantity of columns, of the beamforming matrix, that the second communication apparatus needs to feed back. It may be understood that content omitted in the third column shown in Table 2 may include a compressed beamforming feedback matrix. For details, refer to a related table, related content, or the like. This is not limited in this application.

The index scidx(i) (where i=0, . . . , Ns−1) of the reference subcarrier is determined based on bandwidth (bandwidth, BW) information, partial bandwidth information (partial BW info), and grouping (grouping) information. Ns represents a total quantity of subcarriers. For example, Ns may be a total quantity of subcarriers that needs to be fed back in the beamforming report and that is determined based on the bandwidth information, the partial bandwidth information, and the grouping information. It may be understood that the symbol scidx(i) of the index of the subcarrier shown in this application is merely an example, and the symbol of the index of the subcarrier may alternatively be expressed in another form. This is not limited in this application.

For example, Table 3 shows a division manner of an index of a reference subcarrier shown by using an example in which 20 MHz includes 242 time-frequency units (resource units, RUs), and Table 4 shows a division manner of an index of a reference subcarrier shown by using an example in which 80 MHz includes 996 RUs. It may be understood that the first row in Table 3 and Table 4 represents bandwidth information in the NDPA frame. The second row shown in Table 3 represents a division manner of an index of a reference subcarrier that corresponds to the first 20 MHZ corresponding to the bandwidth information. The third row shown in Table 3 represents a division manner of an index of a reference subcarrier that corresponds to the second 20 MHz corresponding to the bandwidth information. The fourth row shown in Table 3 represents a division manner of an index of a reference subcarrier that corresponds to the third 20 MHz corresponding to the bandwidth information. Descriptions of the fifth row to the seventeenth row shown in Table 3 are deduced by analogy. The second row shown in Table 4 represents a division manner of an index of a reference subcarrier that corresponds to the first 80 MHz corresponding to the bandwidth information. The third row shown in Table 4 represents a division manner of an index of a reference subcarrier that corresponds to the second 80 MHz corresponding to the bandwidth information. Descriptions of the fourth row and the fifth row shown in Table 4 are deduced by analogy. In addition, a difference between Table 3 and Table 4 is that: when the frequency segment indicated by the partial bandwidth information does not cover the entire 80 MHz, the index of the reference subcarrier shown in Table 3 is used; or when the frequency segment indicated by the partial bandwidth information covers the entire 80 MHZ, the index of the reference subcarrier shown in Table 4 is used. For example, if the bandwidth information indicates 80 MHz, and the partial bandwidth information indicates to feed back the first 20 MHz in the 80 MHZ, the second communication apparatus may obtain, based on the fourth column and the second row shown in Table 3, the index, of the reference subcarrier, that needs to be fed back. For another example, if the partial bandwidth information indicates to feed back the second 20 MHz in the 80 MHz, the second communication apparatus may obtain, based on the fourth column and the third row shown in Table 3, the index, of the reference subcarrier, that needs to be fed back. For another example, if the partial bandwidth indicates to feed back the first 40 MHz in the 80 MHz, the second communication apparatus may obtain, based on the fourth column, the second row, and the third row shown in Table 3, the index, of the reference subcarrier, that needs to be fed back. For another example, if the bandwidth information indicates 80 MHz, and the partial bandwidth information indicates to feed back the entire 80 MHZ, the second communication apparatus may obtain, based on the second column and the second row shown in Table 4, the index, of the reference subcarrier, that needs to be fed back. For another example, if the bandwidth information indicates 160 MHz, and the partial bandwidth information indicates to feed back the first 80 MHz, the second communication apparatus may obtain, based on the third column and the second row shown in Table 4, the index, of the reference subcarrier, that needs to be fed back.

TABLE 3

| 242-tone | | | | | |
|---|---|---|---|---|---|
| RU index | 20 MHz | 40 MHz | 80 MHz | 160 MHz | 320 MHz |
| 1 | Ng = 4 | [−244:Ng:−4] | [−500:Ng:−260] | [−1012:Ng:−772] | [−2036:Ng:−1796] |
| | [−122, −120:4:−4, −2, | | | | |
| | 2, 4:4:120, 122] | | | | |
| | Ng = 16 | | | | |
| | [−122, −116:16:−4, −2, | | | | |
| | 2, 4:16:116, 122] | | | | |
| 2 | | [4:Ng:244] | [−252:Ng:−12] | [−764:Ng:−524] | [−1788:Ng:−1548] |
| 3 | | | [12:Ng:252] | [−500:Ng:−260] | [−1524:Ng:1284] |
| 4 | | | [260:Ng:500] | [−252:Ng:−12] | [−1276:Ng:−1036] |
| 5 | | | | [12:Ng:252] | [−1012:Ng:−772] |
| 6 | | | | [260:Ng:500] | [−764:Ng:−524] |
| 7 | | | | [524:Ng:764] | [−500:Ng:−260] |
| 8 | | | | [772:Ng:1012] | [−252:Ng:−12] |
| 9 | | | | | [12:Ng:252] |
| 10 | | | | | [260:Ng:500] |
| 11 | | | | | [524:Ng:764] |
| 12 | | | | | [772:Ng:1012] |
| 13 | | | | | [1036:Ng:1276] |
| 14 | | | | | [1284:Ng:1524] |
| 15 | | | | | [1548:Ng:1788] |
| 16 | | | | | [1796:Ng:2036] |

TABLE 4

| 996-tone RU index | 80 MHz | 160 MHz | 320 MHz |
|---|---|---|---|
| 1 | [−500:4:−4, | [−1012:4:−516, −508:4:−12] | [−2036:4:−1540, −1532:4:−1036] |
| | 4:4:500] | | |
| 2 | | [12:4:508, 516:4:1012] | [−1012:4:−516, −508:4:−12] |
| 3 | | | [12:4:508, 516:4:1012] |
| 4 | | | [1036:4:1532, 1540:4:2036] |

For example, for Table 3, −244:Ng:−4 represents that when an index of a subcarrier is between −244 to −4, Ng may be used as an increment to determine the index of the reference subcarrier. For example, when the channel bandwidth is 40 MHz and Ng=4, −244:4:−4 represents that indexes of reference subcarriers between −244 to −4 are sequentially −244, −240, −236, . . . , −12, −8, and −4. For another example, when the channel bandwidth is 40 MHz and Ng=16, −244:4:−4 represents that indexes of reference subcarriers between −244 to −4 are sequentially −244, −228, −212, . . . , −36, −20, and −4. It may be understood that Table 4 is similar to Table 3. Details are not described herein again. It may be understood that the division manners of the index of the subcarrier shown in Table 3 and Table 4 are merely examples. As the standard evolves, the division manner of the index the reference subcarrier may further include another manner. This is not limited in this application.

For example, when the bandwidth information is 20 MHz, Ng is 4, and the index of the reference subcarrier is scidx(0), it indicates that the index of the reference subcarrier is −122, that is, 0 represents that a location of the index of the reference subcarrier is the 0^{th} location, in the index of the reference subcarrier, that is obtained based on the bandwidth information (20 MHz) and Ng (4). For another example, when the bandwidth information is 20 MHz, Ng is 4, and the index of the reference subcarrier is scidx(1), it indicates that the index of the reference subcarrier is −120, that is, 1 represents that a location of the index of the reference subcarrier is the 1^{st} location, in the index of the reference subcarrier, that is obtained based on the bandwidth information (20 MHZ) and Ng (4). For another example, when the bandwidth information is 40 MHz, Ng is 16, the partial bandwidth information indicates the first 20 MHz in the 40 MHZ, and the index of the reference subcarrier is scidx(Ns−1), it indicates that the index of the reference subcarrier is −4. For another example, when the partial bandwidth information indicates the second 20 MHz in 40 MHz, and the index of the reference subcarrier is scidx(Ns−1), it indicates that the index of the reference subcarrier is 244. For another example, when the partial bandwidth information indicates the entire 40 MHz, and the index of the reference subcarrier is scidx(Ns−1), it indicates that the index of the reference subcarrier is 244. That is, Ns−1 represents that the location of the index of the reference subcarrier is an (Ns−1)^{th} location, in the index of the reference subcarrier, that is obtained based on the bandwidth information (40 MHz), the partial bandwidth information (for example, a part of bandwidth or all bandwidth in the 40 MHZ), and Ng (16). In other words, when the indexes of the reference subcarriers are determined in ascending order of frequencies based on the reference subcarriers obtained based on the bandwidth information, the partial bandwidth information, and the grouping information, i in scidx(i) may represent that the location of the index, of the reference subcarrier, that needs to be fed back in the beamforming report is an i^{th} location in the foregoing determined index of the reference subcarrier. Certainly, when a start location of the index of the reference subcarrier starts from 1, i in scidx(i) may represent that the location of the index, of the reference subcarrier, that needs to be fed back in the beamforming report is an (i+1)^{th} location in the foregoing determined index of the reference subcarrier, where i is an integer greater than or equal to 0. Alternatively, when i is an integer greater than 0, and the start location of the index of the reference subcarrier starts from 1, i in scidx(i) may represent that the location of the index, of the reference subcarrier, that needs to be fed back in the beamforming report is an i^{th} location in the foregoing determined index of the reference subcarrier. Alternatively, when i is an integer greater than 0, and the start location of the index of the reference subcarrier starts from 0, i in scidx(i) may represent that the location of the index, of the reference subcarrier, that needs to be fed back in the beamforming report is an (i−1)^{th} location in the foregoing determined index of the reference subcarrier. It may be understood that a manner of setting the start location of the index of the reference subcarrier is not limited in this application.

However, as system bandwidth continuously increases, a quantity of reference subcarriers included in the beamforming report is increasing, and the generated beamforming report is also increasing. When the beamforming report exceeds 11454 bytes, the beamforming report needs to be segmented, and lengths of all segment except the last segment are the same, for example, may be 11454 bytes. It may be understood that a quantity of bytes of each segment shown herein is merely an example. This is not limited in this application. For example, the beamforming report may be divided into eight segments. It may be understood that the quantity of segments shown herein is merely an example. This is not limited in this application.

For example, the first communication apparatus may send a trigger frame to the second communication apparatus, and the trigger frame may be used to trigger the second communication apparatus to feed back the beamforming report. The trigger frame may include a beamforming report trigger frame (beamforming feedback report poll, BFRP). The trigger frame may include a feedback segment retransmission bitmap subfield (feedback segment retransmission bitmap subfield) (only for example), and a quantity of bits included in the feedback segment retransmission bitmap subfield may be the same as a quantity of segments of the beamforming report. For example, the feedback segment retransmission bitmap subfield may include eight bits, and each bit corresponds to one segment of the beamforming report. For example, when a value of a corresponding bit is 1, it may indicate that a corresponding segment needs to be fed back. As shown in FIG. 3, the first communication apparatus may request one segment from the second communication apparatus each time (only for example). Therefore, if a total quantity of segments in the beamforming report is 8 (where n is used as an example in FIG. 3), the second communication apparatus may separately send eight segments of the beamforming report to the first communication apparatus in eight times. Alternatively, the first communication apparatus may request two segments from the second communication apparatus each time, so that the second communication apparatus may separately send the eight segments of the beamforming report to the first communication apparatus in four times. Alternatively, the first communication apparatus may request eight segments and the like of the beamforming report by using the trigger frame once.

It may be learned from the foregoing that the second communication apparatus needs to feed back all segments of the beamforming report, so that the first communication apparatus can effectively obtain the beamforming matrix. Consequently, signaling overheads occupied by the beamforming report are high.

Further, it may be learned from Table 2 that the indexes, of the reference subcarriers, that are fed back in the beamforming report are determined in ascending order of subcarrier frequencies. In this case, if any segment of the beamforming report fails to be transmitted, the first communication apparatus cannot effectively obtain the beamforming matrix. That is, the first communication apparatus needs to re-obtain the beamforming report. In addition, after the second communication apparatus feeds back the beamforming report to the first communication apparatus, to save a buffer resource, the second communication apparatus deletes the beamforming report. In this case, if any segment of the beamforming report fails to be transmitted, the first communication apparatus needs to interact with the second communication apparatus again, so that the second communication apparatus performs channel measurement again and feeds back the beamforming report again. In the foregoing beamforming report feedback method, if any segment of the beamforming report fails to be transmitted, the beamforming report needs to be fed back again, and the like. Consequently, fault tolerance is poor.

In view of this, this application further provides a beamforming report feedback method and an apparatus. Even if the second communication apparatus feeds back a part of segments of the beamforming report, the first communication apparatus may still obtain the beamforming matrix, to adjust the amplitude and/or the phase of the transmit signal by using the beamforming matrix. Optionally, even if a part of segments of the beamforming report fail to be transmitted, the first communication apparatus may still obtain the beamforming matrix based on the beamforming report. For example, the first communication apparatus may obtain channel state information or beamforming matrix information on larger Ng based on the beamforming report, so that system fault tolerance can be further effectively improved.

It may be understood that the beamforming report shown in this application may also be understood as a compressed beamforming report. For ease of description, in this application, subcarriers obtained according to Table 3 or Table 4 are collectively referred to as reference subcarriers. Indexes of subcarriers that are obtained according to Table 3 or Table 4 are collectively referred to as indexes of reference subcarriers. The reference subcarrier is obtained based on the bandwidth information, the partial bandwidth information, and the grouping information, and the bandwidth information, the partial bandwidth information, and the grouping information may be included in the NDPA frame.

The following describes in detail segmentation of the beamforming report provided in this application.

A quantity of segments (for example, represented by M) of the beamforming report in this application may be equal to N, where N is an integer greater than or equal to 2. N may be an even number, or may be an odd number. This is not limited in this application. For example, N=2, N=4, N=6, N=8, or the like. Certainly, the quantity of segments of the beamforming report shown in this application may be less than N, or may be greater than N. This is not limited in this application. For example, when M is greater than N, it indicates that subcarriers fed back in a part of segments overlap, that is, channel information of a part of subcarriers is allowed to be fed back in different segments. For another example, when M is less than N, only M segments may be fed back, that is, channel information carried by a part of subcarriers is allowed not to be fed back, or is not fed back in any segment. This is not limited in this application.

N may be protocol-predefined, or N may be negotiated by the first communication apparatus and the second communication apparatus, or N may be notified by the first communication apparatus to the second communication apparatus. For example, for an AP and a STA, when the STA accesses the AP, the STA needs to exchange capability information with the AP. Therefore, N shown in this application may be carried in the capability information. For example, the AP sends, to the STA, the capability information that carries N, and after receiving the capability information, the STA feeds back the capability information supported by the STA to the AP. For example, the capability information may carry N. For another example, that the first communication apparatus notifies the second communication apparatus includes: N is included in a trigger frame sent by the first communication apparatus to the second communication apparatus, or Nis included in an NDPA frame sent by the first communication apparatus to the second communication apparatus. A method for setting N is not limited in this application.

M may be protocol-predefined, or M may be negotiated by the first communication apparatus and the second communication apparatus, or M may be notified by the first communication apparatus to the second communication apparatus. Optionally, methods for setting M and N may be the same. For example, both M and N may be negotiated by the first communication apparatus and the second communication apparatus. For example, M and N may be included in same capability information, or may be included in different capability information. This is not limited in this application. For another example, both M and N may be notified by the first communication apparatus to the second communication apparatus. For example, M and N may be included in a same NDPA frame (or a same trigger frame). For another example, M may be included in an NDPA frame, and N is included in a trigger frame. For another example, M may be included in a trigger frame, and N is included in an NDPA frame. This is not limited in this application. Optionally, methods for setting M and N may alternatively be different. For example, M may be negotiated by the first communication apparatus and the second communication apparatus, and N is notified by the first communication apparatus to the second communication apparatus. For another example, M may be protocol-predefined, and N is notified by the first communication apparatus to the second communication apparatus.

For Ng indicated in the NDPA frame, the index, of the reference subcarrier in the beamforming report, that needs to be fed back by the second communication apparatus is scidx(i), where i=0, . . . , Ns−1. However, when the second communication apparatus segments the beamforming report, the following manner may be used:

Optionally, when a start location of the index of the reference subcarrier starts from 0 (that is, i is an integer greater than or equal to 0), indexes of subcarriers in the 0^{th} segment of the beamforming report include scidx(0), scidx(N), scidx(2×N), . . . ; indexes of subcarriers in the 1^{st} segment of the beamforming report include scidx(1), scidx(N+1), scidx(2×N+1), . . . ; and indexes of subcarriers in an (N−1)^{th} segment of the beamforming report include scidx(N−1), scidx(2N−1), scidx(3N−1), . . . . In other words, an index of a subcarrier in a k^{th} segment of the beamforming report is scidx(k+N×i), for example, includes scidx(k), scidx(N+k), scidx(2×N+k), and the like, where k=0, 1, 2, . . . , N−1. That is, locations of the indexes of the subcarriers in the 0^{th} segment include the 0^{th} location, an N^{th} location, a 2N^{th} location, and the like in the indexes of the reference subcarriers. A location space between the N^{th} location and the 0^{th} location is N, a location space between the 2N^{th} location and the 0^{th} location is 2N, and a location space between the 2N^{th} location and the N^{th} location is N. Locations of the indexes of the subcarriers in the 1^{st} segment include the 1^{st} location, the (N+1)^{th} location, the (2N+1)^{th} location, and the like in the indexes of the reference subcarriers. Locations of indexes of subcarriers in the (N−1)^{th} segment include an (N−1)^{th} location, a (2N−1)^{th} location, a (3N−1)^{th} location, and the like in the indexes of the reference subcarriers. In other words, locations of the indexes of the subcarriers in the k^{th} segment of the beamforming report shown in this application include a k^{th} location, a (N+k)^{th} location, a (2×N+k)^{th} location, and the like in the indexes of the reference subcarriers. That is, a space between locations of indexes of any two of at least two subcarriers included in the k^{th} segment of the beamforming report in the indexes of the reference subcarriers is a multiple of N. That a space between locations of indexes of any two of the at least two subcarriers in the indexes of the reference subcarriers is a multiple of N may alternatively be understood as that a space between locations of indexes of neighboring subcarriers in the at least two subcarriers in the indexes of the reference subcarriers is N. For example, if the at least two subcarriers include a first subcarrier and a second subcarrier, a space between locations of an index of the first subcarrier and an index of the second subcarrier in the indexes of the reference subcarriers is a multiple of N. For example, if the location of the index of the first subcarrier in the indexes of the reference subcarriers is the 1^{st} location, and the location of the index of the second subcarrier in the indexes of the reference subcarriers is the 5^{th} location, the space between the locations of the index of the first subcarrier and the index of the second subcarrier in the indexes of the reference subcarriers is 4, or it may be understood as that a difference between the locations of the index of the first subcarrier and the index of the second subcarrier in the indexes of the reference subcarrier is three locations. It may be understood that, when a start segment of the beamforming report starts from 1, that is, k=1, 2, 3, . . . , N, the foregoing manner may also be understood as that: an index of a subcarrier in the k^{th} segment of the beamforming report is scidx(k−1+N×i), for example, includes scidx(k−1), scidx(N+k−1), and scidx(2×N+k−1).

Optionally, when the start location of the index of the reference subcarrier starts from 1 (that is, i is an integer greater than 0), indexes of subcarriers in the 0^{th} segment of the beamforming report include scidx(1), scidx(N+1), scidx(2×N+1), and the like, and indexes of subcarriers in the 1^{st} segment of the beamforming report include scidx(2), scidx(N+2), scidx(2×N+2), and the like. In other words, an index of a subcarrier in the k^{th} segment of the beamforming report is scidx(k+1+N×(i−1)), for example, includes scidx(k+1), scidx(N+k+1), and scidx(2×N+k+1), where k=0, 1, 2, . . . , N−1. Alternatively, when k is an integer greater than 0, that is, when the start segment of the beamforming report starts from 1, an index of a subcarrier in the k^{th} segment of the beamforming report is scidx(k+N×(i−1)), for example, includes scidx(k), scidx(N+k), and scidx(2×N+k), where k=1, 2, . . . , N−1.

It may be understood that the start location of the index of the reference subcarrier and the start segment of the beamforming report that are shown above are merely examples. This is not limited in this application. For ease of description, the following uses an example in which the start location of the index of the reference subcarrier is 0 (that is, i is an integer greater than or equal to 0) and the start segment of the beamforming report is 0 (that is, k is an integer greater than or equal to 0) for description.

Therefore, when the first communication apparatus receives at least one segment of the beamforming report, or when the first communication apparatus successfully receives at least one segment of the beamforming report, the first communication apparatus may equivalently obtain a beamforming report with larger Ng (for example, 2Ng, 3Ng, or N×Ng). That is, although the first communication apparatus obtains only a part of segments (or may be all segments and the like) of the beamforming report, and each segment indicates channel information on at least two subcarriers, because subcarriers fed back in each segment are distributed on the reference subcarrier, it is equivalent to that the first communication apparatus obtains channel information corresponding to Ng′ greater than specified Ng.

For example, the method provided in this application may have the following cases:
Case 1: The second communication apparatus feeds back one segment of the beamforming report, or one segment of the beamforming report is successfully transmitted. After the first communication apparatus receives the segment, it may be equivalent to obtaining the beamforming report in a case of Ng′=N× Ng. For example, the segment includes the first segment, and an index of an i^{th} subcarrier in the first segment is scidx(k+N×i), where k represents that the first segment is a k^{th} segment in N segments of the beamforming report. For example, if k−0, and N=4, the indexes of the subcarriers in the first segment include scidx(0), scidx(4), scidx(8), . . . . That is, locations of the indexes of the subcarriers in the first segment are respectively the 0^{th} location, the 4^{th} location, the 8^{th} location, and the like in the indexes of the reference subcarriers. For example, in a case in which Ng=4 (which may be understood as that channel information of one subcarrier in every four subcarriers is fed back), the indexes of the reference subcarriers are sequentially scidx(0), scidx(1), . . . , scidx(8), and the like. Therefore, based on the channel information that is of the subcarrier and that is fed back in the first segment, it may be equivalent to that the second communication apparatus feeds back channel information of one subcarrier in every 16 subcarriers, that is, it is equivalent to that the first communication apparatus obtains channel information when Ng′=16.

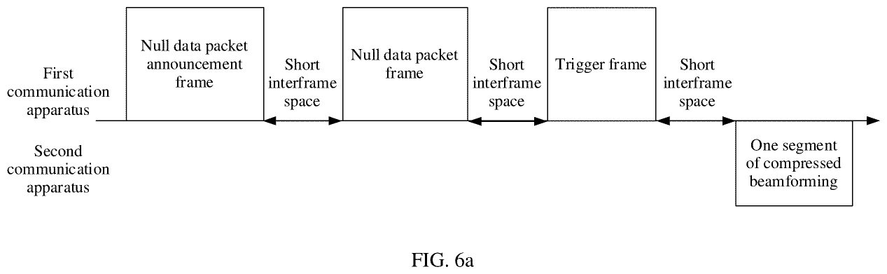

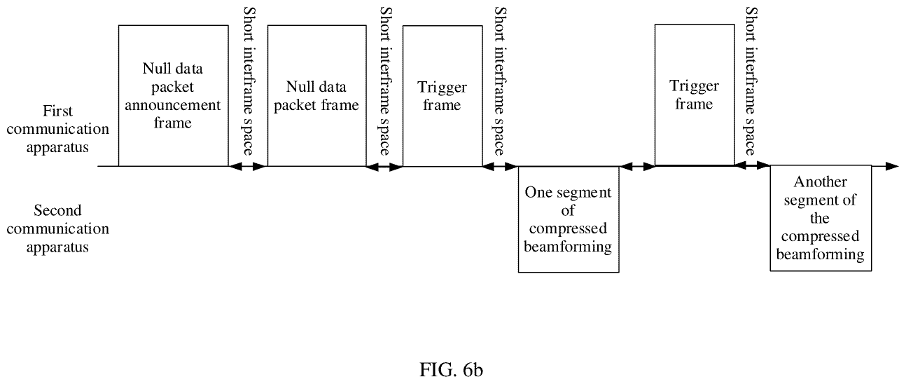

For example, FIG. 6a is a schematic diagram of a scenario in which the first communication apparatus triggers, by using a trigger frame, the second communication apparatus to feed back one segment. As shown in FIG. 6a, the first communication apparatus may request one segment (for example, the first segment) of the beamforming report from the second communication apparatus by using one trigger frame. After the second communication apparatus feeds back the first segment based on the trigger frame, the first communication apparatus may obtain the beamforming report based on the first segment in a case of Ng′. Therefore, this not only effectively reduces signaling overheads of the beamforming report, but also can ensure that the first communication apparatus may still obtain the beamforming report.
Case 2: The second communication apparatus feeds back two segments of the beamforming report, or two segments of the beamforming report are successfully transmitted. After the first communication apparatus receives the two segments, it may be equivalent to obtaining the beamforming report in a case of Ng′=N× Ng/2. For example, the two segments include a first segment and a second segment, an index of an i^{th} subcarrier in the first segment is scidx(k+N×i), and an index of an i^{th} subcarrier in the second segment is scidx(k+N/2+N×i). For example, FIG. 6b is a schematic diagram of a scenario in which the first communication apparatus triggers, by using a trigger frame, the second communication apparatus to feed back two segments. For descriptions of FIG. 6b, refer to FIG. 6a, FIG. 3, or the like. Details are not described herein again.
Case 3: The second communication apparatus feeds back four segments of the beamforming report, or four segments of the beamforming report are successfully transmitted. After the first communication apparatus receives the four segments, it may be equivalent to obtaining the beamforming report in a case of Ng′=N× Ng/4.

For example, Table 5 shows another compressed beamforming report shown in this embodiment of this application.

TABLE 5

| Field (field) | Size (size)/bits | Meaning (meaning) |
|---|---|---|
| Average signal-to-noise ratio of space- | 8 | Signal-to-noise ratio at a |
| time stream 1 (average SNR of space- | | beamformee for space- |
| time 1) | | time stream 1 averaged |
| | | over all data subcarriers |
| | | (signal-to-noise ratio at a |
| | | beamformee for space- |
| | | time stream 1 averaged |
| | | over all data subcarrier) |
| . . . | . . . | . . . |
| Average signal-to-noise ratio of space- | 8 | Signal-to-noise ratio at the |
| time stream Nc (average SNR of space- | | beamformee for the space- |
| time Nc) | | time stream Nc averaged |
| | | over all data subcarriers |
| Compressed beamforming feedback | Na × (b_{Ø} + b_{φ})/2 | . . . |
| matrix V for an index k = scidx(0) of a | | |
| subcarrier (compressed beamforming | | |
| feedback matrix V for an index | | |
| k = scidx(0) of a subcarrier) | | |
| Compressed beamforming feedback | Na × (b_{Ø} + b_{φ})/2 | . . . |
| matrix V for an index k = scidx(N) of a | | |
| subcarrier | | |
| Compressed beamforming feedback | Na × (b_{Ø} + b_{φ})/2 | . . . |
| matrix V for an index k = scidx(2 × N) of a | | |
| subcarrier | | |
| . . . | . . . | . . . |
| Compressed beamforming feedback | Na × (b_{Ø} + b_{φ})/2 | . . . |
| matrix V for an index k = scidx(1) of a | | |
| subcarrier | | |
| Compressed beamforming feedback | Na × (b_{Ø} + b_{φ})/2 | . . . |
| matrix V for an index k = scidx(N + 1) of a | | |
| subcarrier | | |
| . . . | . . . | . . . |
| Compressed beamforming feedback | Na × (b_{Ø} + b_{φ})/2 | . . . |
| matrix V for an index k = scidx(2) of a | | |
| subcarrier | | |
| Compressed beamforming feedback | Na × (b_{Ø} + b_{φ})/2 | . . . |
| matrix V for an index k = scidx(N + 2) of a | | |
| subcarrier | | |
| . . . | . . . | . . . |
| Compressed beamforming feedback | Na × (b_{Ø} + b_{φ})/2 | . . . |
| matrix V for an index k = scidx(Ns − 1) of | | |
| a subcarrier | | |

The first column represents an index of a subcarrier, and the beamforming feedback matrix shown above is the beamforming matrix shown in this application. The second column represents a quantity of bits corresponding to content indicated by the first column. It may be understood that for specific descriptions of Table 5, refer to Table 2. Details are not described herein again. A difference between Table 5 and Table 2 is that: indexes of reference subcarriers fed back in the beamforming report shown in Table 2 are determined in ascending order of subcarrier frequencies, and a difference between indexes of adjacent reference subcarriers in a k^{th} segment of the beamforming report shown in Table 2 is Ng (bandwidth other than 20 MHz). An index of a subcarrier fed back in the beamforming report shown in Table 5 is determined according to the method shown above in this application. For example, an index of a subcarrier in the k^{th} segment of the beamforming report is scidx(k+N×i). The beamforming report shown in Table 5 is used, so that the index of the subcarrier in each segment may be approximately distributed in the entire frequency segment that needs to be fed back.

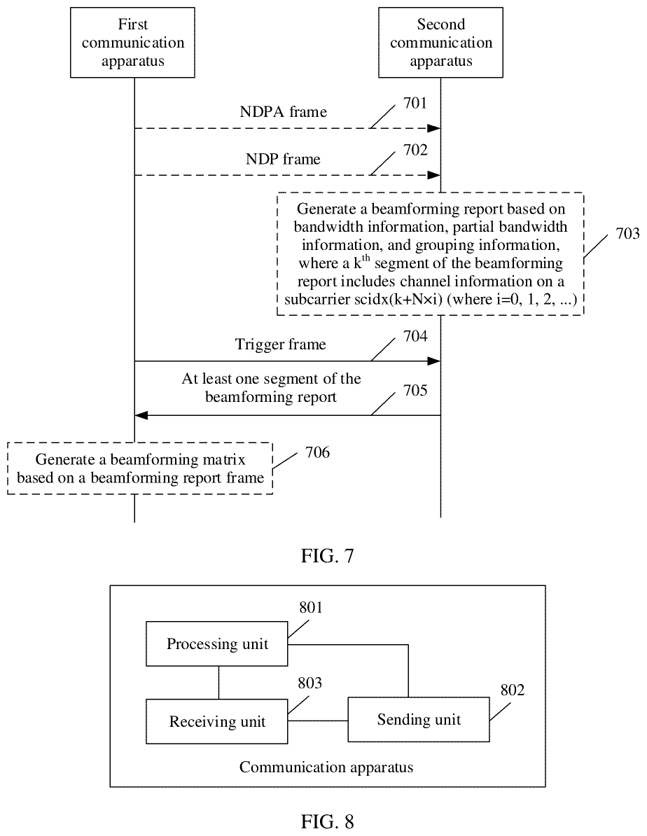

With reference to the beamforming report shown above, this application further provides a beamforming report feedback method. FIG. 7 is a schematic interaction diagram of a beamforming report feedback method according to an embodiment of this application. The method may be applied to a first communication apparatus and a second communication apparatus. For specific descriptions of the first communication apparatus and the second communication apparatus, refer to the foregoing descriptions. Details are not described herein again. As shown in FIG. 7, the method includes the following steps.

In a possible implementation, the method shown in FIG. 7 includes step 701 to step 703.
701: The first communication apparatus sends an NDPA frame to the second communication apparatus, and correspondingly the second communication apparatus receives the NDPA frame.

The NDPA frame includes bandwidth information, partial bandwidth information, and grouping information. It may be understood that for specific descriptions of the bandwidth information, the partial bandwidth information, and the grouping information, refer to the foregoing descriptions. Details are not described herein again.
702: The first communication apparatus sends an NDP frame to the second communication apparatus, and correspondingly the second communication apparatus receives the NDP frame.

The NDP frame may be used for channel estimation.
703: The second communication apparatus generates a beamforming report based on the bandwidth information, the partial bandwidth information, and the grouping information, where a k^{th} segment of the beamforming report includes channel information on a subcarrier scidx(k+N×i) (where i=0, 1, 2, . . . ).

The channel information includes any one or more of CSI, channel quality indication (channel quality indication, CQI) information, beamforming matrix information, or the like.

Optionally, the second communication apparatus determines, based on the bandwidth information, the partial bandwidth information, and the grouping information, an index scidx(i) (where i=0, . . . , Ns−1), of a reference subcarrier, that needs to be fed back, and separately performs channel estimation on subcarriers corresponding to the index of the reference subcarrier, to obtain a channel measurement result (for example, a channel matrix). An SVD decomposition is performed on the channel measurement result to obtain a beamforming matrix. Optionally, the beamforming matrix may be further compressed to obtain a compressed beamforming matrix.
704: The first communication apparatus sends a trigger frame to the second communication apparatus, and correspondingly the second communication apparatus receives the trigger frame.

For example, the trigger frame includes first information, and the first information may indicate at least one segment for feeding back the beamforming report by the second communication apparatus. For example, the first information may include M bits, and each bit may correspond to a segment of the beamforming report. For example, a value of each bit may indicate whether the second communication apparatus needs to feed back a corresponding segment. Optionally, M=N. For a relationship between M and N, refer to the foregoing descriptions. Details are not described herein again. It may be understood that the first information shown in this application may include a feedback segment retransmission bitmap subfield (feedback segment retransmission bitmap subfield), or may have another name, or the like. This is not limited in this embodiment of this application.

For example, the first information is 1000. If 1 represents that a corresponding segment needs to be fed back, and 0 represents that a corresponding segment does not need to be fed back, the first information may indicate that the 0^{th} segment of the beamforming report needs to be fed back. For another example, if the first information is 1010, it indicates that the 0^{th} segment and the 2^{nd} segment of the beamforming report need to be fed back. For another example, if the first information is 0101, it indicates that the 1^{st} segment and the 3^{rd} segment of the beamforming report need to be fed back.

Optionally, after obtaining the trigger frame, the second communication apparatus may determine, based on values of the M bits in the trigger frame, a segment (for example, a first segment), of the beamforming matrix, that needs to be fed back. Therefore, the second communication apparatus feeds back the first segment by using a beamforming report frame.

Optionally, after obtaining the trigger frame, the second communication apparatus may further determine, based on values of the M bits in the trigger frame, a segment (for example, the first segment), of the beamforming matrix, that needs to be fed back. Therefore, the second communication apparatus may perform channel estimation only on a subcarrier included in the first segment, to obtain a channel measurement result of the subcarrier included in the first segment. Further, the first segment is fed back in the beamforming report frame.
705: The second communication apparatus sends at least one segment of the beamforming report to the first communication apparatus, where the at least one segment includes the first segment. Correspondingly, the first communication apparatus receives the at least one segment of the beamforming report.

For example, if the first information indicates to feed back one segment of the beamforming report, it indicates that the second communication apparatus may feed back only one segment (for example, the first segment). In this case, the first communication apparatus may obtain the channel measurement result based on the first segment in a case of N×Ng. For another example, if the first information indicates to feed back two segments of the beamforming report, it indicates that the second communication apparatus may feed back two segments. In this case, the first communication apparatus may obtain the channel measurement result based on the two segments in a case of N×Ng/2. For another example, the first information may indicate to feed back all segments of the beamforming report. In this case, even if a part of segments fail to be transmitted, the first communication apparatus may still obtain the channel measurement result in a case of N×Ng, N×Ng/2, N×Ng/4, or the like.

In a possible implementation, the method shown in FIG. 7 includes step 706.
706: The first communication apparatus generates the beamforming matrix based on the beamforming report frame.

Optionally, when channel state information is fed back in the beamforming report frame, the first communication apparatus may perform the SVD decomposition based on the channel state information to obtain the beamforming matrix.

Optionally, when beamforming matrix information (for example, angle information) is fed back in the beamforming report frame, the first communication apparatus may obtain the beamforming matrix based on the beamforming matrix and Givins rotation.

Optionally, when a channel quality indication is fed back in the beamforming report frame, the first communication apparatus may perform the SVD decomposition based on the channel quality indication to obtain the beamforming matrix.

It may be understood that for related descriptions of the method shown in FIG. 7, refer to FIG. 3, FIG. 4, or the like described above. Details are not described herein again one by one.

In this embodiment of this application, when the first communication apparatus obtains the at least one segment of the beamforming report, because a space between locations of indexes, of at least two subcarriers included in the at least one segment such as the first segment, that are in indexes of reference subcarriers is a multiple of N, that is, the at least two subcarriers included in the first segment may be distributed on the reference subcarriers, the first communication apparatus may equivalently obtain a channel measurement result corresponding to a quantity of groups (for example, Ng′) greater than that of the grouping information (for example, Ng). Therefore, according to the method provided in this embodiment of this application, even if the first communication apparatus receives a part of segments, the first communication apparatus can still equivalently obtain, based on the part of segments, the channel measurement result corresponding to quantity of groups, for example, Ng′. This improves a case in which all segments of the beamforming report need to be transmitted, and effectively reduces signaling overheads of the beamforming report. Optionally, when the first communication apparatus requests to obtain at least two segments, even if a part of the at least two segments fail to be transmitted, the first communication apparatus may still obtain the beamforming matrix provided that one segment is successfully transmitted, thereby effectively improving flexibility of beamforming report segmentation transmission. Optionally, according to the method provided in this embodiment of this application, when the first communication apparatus obtains the at least one segment, the at least one segment can be a channel measurement result corresponding to a larger Ng value, and subcarriers of different segments do not overlap with each other (for example, when M=N). Therefore, even if a part of segments fails to be transmitted, the first communication apparatus may still obtain the channel measurement result corresponding to the larger Ng value, so that a system supports a more flexible Ng measurement result feedback.

The following describes communication apparatuses provided in embodiments of this application.

In this application, division into functional modules is performed on the communication apparatus based on the foregoing method embodiments. For example, each functional module may be obtained through division based on each corresponding function, or two or more functions may be integrated into one processing module. The integrated module may be implemented in a form of hardware, or may be implemented in a form of a software functional module. It should be noted that in this application, division into modules is an example, and is merely logical function division. During actual implementation, another division manner may be used. The following describes in detail communication apparatuses in embodiments of this application with reference to FIG. 8 and FIG. 10.

FIG. 8 is a schematic diagram of a structure of a communication apparatus according to an embodiment of this application. As shown in FIG. 8, the communication apparatus includes a processing unit 801, a sending unit 802, and a receiving unit 803.

In some embodiments of this application, the communication apparatus may be the first communication apparatus shown above. To be specific, the communication apparatus shown in FIG. 8 may be configured to perform the steps, functions, or the like performed by the first communication apparatus in the foregoing method embodiments. For example, the first communication apparatus may be a beamforming transmit device, a chip, or the like. This is not limited in this embodiment of this application.

The sending unit 802 is configured to send a trigger frame to a second communication apparatus.

The receiving unit 803 is configured to receive a beamforming report frame from the second communication apparatus, where the beamforming report frame includes at least one segment, for example, a first segment.

Optionally, the processing unit 801 is configured to generate the trigger frame. For another example, the processing unit 801 is further configured to process the beamforming report frame and obtain a beamforming matrix.

Optionally, the processing unit 801 is further configured to control the sending unit 802 to output the trigger frame.

Optionally, the processing unit 801 is further configured to generate an NDPA frame. For another example, the processing unit 801 is further configured to generate an NDP frame.

Optionally, the sending unit 802 is further configured to send the NDPA frame to the second communication apparatus and send the NDP frame to the second communication apparatus.

It may be understood that for specific descriptions of the trigger frame, the beamforming report frame, the NDPA frame, the NDP frame, a segment of a beamforming report, an index of a reference subcarrier, or the like, refer to the foregoing method embodiments, for example, the methods shown in FIG. 3, FIG. 4, and FIG. 7, or refer to related descriptions of Table 1 to Table 5. Details are not described herein again.

It may be understood that specific descriptions of the transceiver unit and the processing unit described in this embodiment of this application are merely examples. For specific functions, performed steps, or the like of the transceiver unit and the processing unit, refer to the foregoing method embodiments. Details are not described herein again. For example, the sending unit 802 may be further configured to perform the sending steps in step 701, step 702, and step 704 shown in FIG. 7. The receiving unit 803 is further configured to perform the receiving step in step 705 shown in FIG. 7. The processing unit 801 may be further configured to perform step 706 shown in FIG. 7.

FIG. 8 is reused. In some other embodiments of this application, the communication apparatus may be the second communication apparatus shown above. To be specific, the communication apparatus shown in FIG. 8 may be configured to perform the steps, functions, or the like performed by the second communication apparatus in the foregoing method embodiments. For example, the second communication apparatus may be a beamforming receive device, a chip, or the like. This is not limited in this embodiment of this application.

The receiving unit 803 is configured to receive a trigger frame from a first communication apparatus.

The sending unit 802 is configured to send a beamforming report frame to the first communication apparatus, where the beamforming report frame includes at least one segment, for example, a first segment.

Optionally, the processing unit 801 is configured to generate the beamforming report frame. For another example, the processing unit 801 is further configured to control the sending unit 802 to output the beamforming report frame.

Optionally, the receiving unit 803 is further configured to receive an NDPA frame from the first communication apparatus and receive an NDP frame from the first communication apparatus.

Optionally, the processing unit 801 is further configured to process the NDPA frame. For example, the processing unit 801 may determine an index of a reference subcarrier or the like based on bandwidth information, partial bandwidth information, and grouping information in the NDPA frame.

Optionally, the processing unit 801 is further configured to process the NDP frame. For example, the processing unit 801 may perform channel estimation and the like based on the NDP frame.

Optionally, the processing unit 801 is further configured to segment a beamforming report, and the like.

It may be understood that for specific descriptions of the trigger frame, the beamforming report frame, the NDPA frame, the NDP frame, a segment of the beamforming report, an index of a reference subcarrier, or the like, refer to the foregoing method embodiments, for example, the methods shown in FIG. 3, FIG. 4, and FIG. 7, or refer to related descriptions of Table 1 to Table 5. Details are not described herein again.

It may be understood that specific descriptions of the transceiver unit and the processing unit described in this embodiment of this application are merely examples. For specific functions, performed steps, or the like of the transceiver unit and the processing unit, refer to the foregoing method embodiments. Details are not described herein again. For example, the receiving unit 803 may be further configured to perform the receiving steps in step 701 and step 702 shown in FIG. 7. The processing unit 801 may be further configured to perform step 703 shown in FIG. 7. The receiving unit 803 may be further configured to perform the receiving step in step 704 shown in FIG. 7. The sending unit 802 is further configured to perform the sending step in step 705 shown in FIG. 7.

The foregoing describes the first communication apparatus and the second communication apparatus in embodiments of this application. The following describes possible product forms of the first communication apparatus and the second communication apparatus. It should be understood that any form of product having a function of the first communication apparatus in FIG. 8 and any form of product having a function of the second communication apparatus in FIG. 8 both fall within the protection scope of embodiments of this application. It should be further understood that the following descriptions are merely an example, and the product forms of the first communication apparatus and the second communication apparatus in embodiments of this application are not limited thereto.

In the communication apparatus shown in FIG. 8, the processing unit 801 may be one or more processors, the sending unit 802 may be a transmitter, and the receiving unit 803 may be a receiver. Alternatively, the sending unit 802 and the receiving unit 803 are integrated into one component, for example, a transceiver. Alternatively, the processing unit 801 may be one or more processors (or the processing unit 801 may be one or more logic circuits), the sending unit 802 may be an output interface, and the receiving unit 803 may be an input interface. Alternatively, the sending unit 802 and the receiving unit 803 are integrated into one unit, for example, an input/output interface. Details are described below.

In a possible implementation, in the communication apparatus shown in FIG. 8, the processing unit 801 may be one or more processors, and the sending unit 802 and the receiving unit 803 may be integrated into a transceiver. In this embodiment of this application, the processor and the transceiver may be coupled, or the like. A connection manner between the processor and the transceiver is not limited in this embodiment of this application.

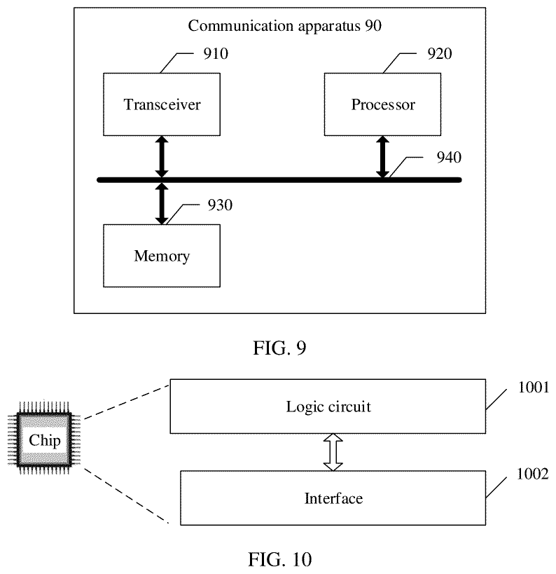

As shown in FIG. 9, the communication apparatus 90 includes one or more processors 920 and a transceiver 910.

For example, when the communication apparatus is configured to perform the steps, the methods, or the functions performed by the first communication apparatus, the transceiver 910 is configured to send a trigger frame to a second communication apparatus and receive a beamforming report frame from the second communication apparatus. Optionally, the processor 920 is configured to determine a beamforming matrix based on the beamforming report frame. Optionally, the transceiver 910 is further configured to send an NDPA frame, an NDP frame, and the like to the second communication apparatus.

For example, when the communication apparatus is configured to perform the steps, the methods, or the functions performed by the second communication apparatus, the transceiver 910 is configured to receive a trigger frame from a first communication apparatus and send a beamforming report frame to the first communication apparatus. Optionally, the processor 920 is configured to generate the beamforming report frame and the like. Optionally, the transceiver 910 is further configured to receive an NDPA frame, an NDP frame, and the like from the first communication apparatus. Optionally, the processor 920 is further configured to process the NDPA frame, the NDP frame, and/or the like.

It may be understood that for specific descriptions of the trigger frame, the beamforming report frame, the NDPA frame, the NDP frame, a segment of a beamforming report, an index of a reference subcarrier, or the like, refer to the foregoing method embodiments, for example, the methods shown in FIG. 3, FIG. 4, and FIG. 7, or refer to related descriptions of Table 1 to Table 5. Details are not described herein again.

It may be understood that for specific descriptions of the processor and the transceiver, refer to descriptions of the processing unit, the sending unit, and the receiving unit shown in FIG. 8. Details are not described herein again.

In each implementation of the communication apparatus shown in FIG. 9, the transceiver may include a receiver machine and a transmitter machine. The receiver machine is configured to perform a receiving function (or operation), and the transmitter machine is configured to perform a transmitting function (or operation). In addition, the transceiver is configured to communicate with another device/apparatus through a transmission medium.

Optionally, the communication apparatus 90 may further include one or more memories 930, configured to store program instructions and/or data. The memory 930 is coupled to the processor 920. The coupling in this embodiment of this application is an indirect coupling or a communication connection between apparatuses, units, or modules, may be in an electrical form, a mechanical form, or another form, and is used for information exchange between the apparatuses, the units, or the modules. The processor 920 may operate in collaboration with the memory 930. The processor 920 may execute the program instructions stored in the memory 930. Optionally, at least one of the one or more memories may be included in the processor.

A specific connection medium between the transceiver 910, the processor 920, and the memory 930 is not limited in this embodiment of this application. In this embodiment of this application, the memory 930, the processor 920, and the transceiver 910 are connected through a bus 940 in FIG. 9. The bus is represented by using a bold line in FIG. 9. A manner of connection between other components is merely an example for description, and is not limited thereto. The bus may be classified into an address bus, a data bus, a control bus, and the like. For ease of representation, the bus is represented by using only one bold line in FIG. 9. However, this does not indicate that there is only one bus or only one type of bus.

In embodiments of this application, the processor may be a general-purpose processor, a digital signal processor, an application-specific integrated circuit, a field programmable gate array or another programmable logic device, a discrete gate or a transistor logic device, or a discrete hardware component, and may implement or execute the methods, steps, and logical block diagrams disclosed in embodiments of this application. The general-purpose processor may be a microprocessor or any conventional processor or the like. The steps of the methods disclosed with reference to embodiments of this application may be directly executed and accomplished by a hardware processor, or may be executed and accomplished by using a combination of hardware and software modules in the processor.

In embodiments of this application, the memory may include but is not limited to a nonvolatile memory, for example, a hard disk drive (hard disk drive, HDD) or a solid-state drive (solid-state drive, SSD), a random access memory (Random Access Memory, RAM), an erasable programmable read-only memory (Erasable Programmable ROM, EPROM), a read-only memory (Read-Only Memory, ROM), or a compact disc read-only memory (Compact Disc Read-Only Memory, CD-ROM). The memory is any storage medium that can be used to carry or store program code in a form of instructions or a data structure and that can be read and/or written by a computer (for example, the communication apparatus shown in this application). However, this is not limited thereto. The memory in embodiments of this application may alternatively be a circuit or any other apparatus that can implement a storage function, and is configured to store the program instructions and/or the data.

The processor 920 is mainly configured to process a communication protocol and communication data, control the entire communication apparatus, execute a software program, and process data of the software program. The memory 930 is mainly configured to store a software program and data. The transceiver 910 may include a control circuit and an antenna. The control circuit is mainly configured to perform conversion between a baseband signal and a radio frequency signal and process the radio frequency signal. The antenna is mainly configured to receive and send a radio frequency signal in a form of an electromagnetic wave. The input/output apparatus, for example, a touchscreen, a display, or a keyboard, is mainly configured to receive data input by a user and output data to the user.

After the communication apparatus is powered on, the processor 920 may read the software program in the memory 930, interpret and execute instructions of the software program, and process data of the software program. When data needs to be sent in a wireless manner, the processor 920 performs baseband processing on the to-be-sent data, and then outputs a baseband signal to a radio frequency circuit. The radio frequency circuit performs radio frequency processing on the baseband signal, and then sends, through the antenna, a radio frequency signal in a form of an electromagnetic wave. When data is sent to the communication apparatus, the radio frequency circuit receives a radio frequency signal through the antenna, converts the radio frequency signal into a baseband signal, and outputs the baseband signal to the processor 920. The processor 920 converts the baseband signal into data, and processes the data.

In another implementation, the radio frequency circuit and the antenna may be disposed independent of the processor that performs baseband processing. For example, in a distributed scenario, the radio frequency circuit and the antenna may be disposed remotely and independent of the communication apparatus.

It may be understood that the communication apparatus shown in this embodiment of this application may further have more components and the like than those in FIG. 9. This is not limited in this embodiment of this application. The methods performed by the processor and the transceiver are merely examples. For specific steps performed by the processor and the transceiver, refer to the methods described above.

In another possible implementation, in the communication apparatus shown in FIG. 8, the processing unit 801 may be one or more logic circuits, the sending unit 802 may be an output interface, and the receiving unit 803 may be an input interface. Alternatively, the sending unit 802 and the receiving unit 803 may be integrated into one unit, for example, an input/output interface. The input/output interface is also referred to as a communication interface, an interface circuit, an interface, or the like. As shown in FIG. 10, the communication apparatus shown in FIG. 10 includes a logic circuit 1001 and an interface 1002. That is, the processing unit 801 may be implemented through the logic circuit 1001, and the sending unit 802 and the receiving unit 803 may be implemented through the interface 1002. The logic circuit 1001 may be used as a chip, a processing circuit, an integrated circuit, a system on chip (system on chip, SoC) chip, or the like, and the interface 1002 may be used as a communication interface, an input/output interface, a pin, or the like. For example, in FIG. 10, an example in which the communication apparatus is a chip is used, and the chip includes a logic circuit 1001 and an interface 1002.

In this embodiment of this application, the logic circuit may be further coupled to the interface. A specific connection manner of the logical circuit and the interface is not limited in this embodiment of this application.

For example, when the communication apparatus is configured to perform the method, the function, or the step performed by the first communication apparatus, the interface 1002 is configured to output a trigger frame and input a beamforming report frame. Optionally, the logic circuit 1001 is configured to determine a beamforming matrix and the like based on the beamforming report frame. Optionally, the logic circuit 1001 is further configured to generate an NDPA frame, and the interface 1002 is further configured to output the NDPA frame. Optionally, the logic circuit 1001 is further configured to generate an NDP frame, and the interface 1002 is further configured to output the NDP frame.

For example, when the communication apparatus is configured to perform the method, the function, or the step performed by the second communication apparatus, the interface 1002 is configured to input a trigger frame and output a beamforming report frame. Optionally, the logic circuit 1001 is configured to generate the beamforming report frame. Optionally, the interface 1002 is further configured to input an NDPA frame, and the logic circuit 1001 is further configured to process the NDPA frame. Optionally, the interface 1002 is further configured to input an NDP frame, and the logic circuit 1001 is further configured to process the NDP frame (for example, perform channel estimation and the like based on the NDP frame).

It may be understood that the communication apparatus shown in this embodiment of this application may implement the method provided in embodiments of this application in a form of hardware or in a form of software. This is not limited in embodiments of this application.

It may be understood that for specific descriptions of the trigger frame, the beamforming report frame, the NDPA frame, the NDP frame, a segment of a beamforming report, an index of a reference subcarrier, or the like, refer to the foregoing method embodiments, for example, the methods shown in FIG. 3, FIG. 4, and FIG. 7, or refer to related descriptions of Table 1 to Table 5. Details are not described herein again.

For specific implementations of the embodiments shown in FIG. 10, refer to the foregoing embodiments. Details are not described herein again.

An embodiment of this application further provides a wireless communication system. The wireless communication system includes a first communication apparatus and a second communication apparatus. The first communication apparatus and the second communication apparatus may be configured to perform the method in any one of the foregoing embodiments (as shown in FIG. 3, FIG. 4, FIG. 6a, FIG. 6b, FIG. 7, and the like).

In addition, this application further provides a computer program. The computer program is used to implement operations and/or processing performed by the first communication apparatus in the method provided in this application.

This application further provides a computer program. The computer program is used to implement operations and/or processing performed by the second communication apparatus in the method provided in this application.

This application further provides a computer-readable storage medium. The computer-readable storage medium stores computer code. When the computer code is run on a computer, the computer is enabled to perform operations and/or processing performed by the first communication apparatus in the method provided in this application.

This application further provides a computer-readable storage medium. The computer-readable storage medium stores computer code. When the computer code is run on a computer, the computer is enabled to perform operations and/or processing performed by the second communication apparatus in the method provided in this application.

This application further provides a computer program product. The computer program product includes computer code or a computer program. When the computer code or the computer program is run on a computer, operations and/or processing performed by the first communication apparatus in the method provided in this application are/is performed.

This application further provides a computer program product. The computer program product includes computer code or a computer program. When the computer code or the computer program is run on a computer, operations and/or processing performed by the second communication apparatus in the method provided in this application are/is performed.

In several embodiments provided in this application, it should be understood that the disclosed system, apparatus, and method may be implemented in other manners. For example, the described apparatus embodiments are merely examples. For example, division into the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or other forms.

The units described as separate parts may or may not be physically separate, and parts displayed as units may or may not be physical units, that is, may be located in one place, or may be distributed on a plurality of network units. Some or all of the units may be selected based on actual requirements to achieve the technical effects of the solutions provided in embodiments in this application.

In addition, functional units in embodiments of this application may be integrated into one processing unit, each of the units may exist alone physically, or two or more units are integrated into one unit. The integrated unit may be implemented in a form of hardware, or may be implemented in a form of a software functional unit.

When the integrated unit is implemented in the form of the software functional unit and sold or used as an independent product, the integrated unit may be stored in a computer-readable storage medium. Based on such an understanding, the technical solutions of this application essentially, or the part contributing to the conventional technology, or all or some of the technical solutions may be implemented in a form of a software product. The computer software product is stored in a readable-storage medium, and includes several instructions for instructing a computer device (which may be a personal computer, a server, a network device, or the like) to perform all or some of the steps of the methods described in embodiments of this application. The readable-storage medium includes any medium that can store program code, such as a USB flash drive, a removable hard disk, a read-only memory (read-only memory, ROM), a random access memory (random access memory, RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A beamforming report feedback method, wherein the method comprises:
sending, by a first communication apparatus, a trigger frame to a second communication apparatus, wherein the trigger frame comprises first information, the first information indicates the second communication apparatus to feed back at least one segment of a beamforming report, the at least one segment comprises a first segment, and the beamforming report is used to report channel information between the first communication apparatus and the second communication apparatus; and
receiving, by the first communication apparatus, a beamforming report frame from the second communication apparatus, wherein the beamforming report frame comprises the first segment, the first segment indicates channel information on at least two subcarriers, a space between locations of indexes of any two of the at least two subcarriers in indexes of reference subcarriers is a multiple of N, the reference subcarriers are obtained based on bandwidth information, partial bandwidth information, and grouping information, and N is an integer greater than or equal to 2.

2. The method according to claim 1, wherein the first information comprises M bits, each of the M bits corresponds to a segment of the beamforming report, a value of each bit indicates whether to feed back the corresponding segment, and M is an integer greater than or equal to 2.

3. The method according to claim 1, wherein the indexes of the reference subcarriers in ascending order of frequencies are scidx(0), scidx(1), . . . , and scidx(Ns−1), wherein Ns is a total quantity of subcarriers comprised in the reference subcarriers, and Ns and the indexes of the reference subcarriers are obtained based on the bandwidth information, the partial bandwidth information, and the grouping information; and
an index of an i^{th} subcarrier in the first segment is scidx(k+N×i), wherein k indicates that the first segment is a k^{th} segment of the beamforming report, k is an integer greater than or equal to 0, and i is an integer greater than or equal to 0.

4. The method according to claim 1, wherein N is a predefined integer, or Nis negotiated by the first communication apparatus and the second communication apparatus, or N is notified by the first communication apparatus to the second communication apparatus.

5. The method according to claim 1, wherein the method further comprises:
generating, by the first communication apparatus, a beamforming matrix based on the beamforming report frame, wherein the beamforming matrix is used to adjust an amplitude and/or a phase of a to-be-sent signal.

6. The method according to claim 1, wherein before the sending, by a first communication apparatus, a trigger frame to a second communication apparatus, the method further comprises:
sending, by the first communication apparatus, a null data packet announcement (NDPA) frame to the second communication apparatus, wherein the NDPA frame comprises the bandwidth information, the partial bandwidth information, and the grouping information, the bandwidth information indicates bandwidth of a channel measurement reference signal, the partial bandwidth information indicates a frequency segment in which the at least two subcarriers are located, and the grouping information indicates that channel information of one subcarrier in every Ng subcarriers is fed back; and
sending, by the first communication apparatus, a null data packet NDP frame to the second communication apparatus, wherein the NDP frame is used for channel estimation.

7. A first communication apparatus, wherein the apparatus comprises at least one processor, the at least one processor configured to implement a method, comprising:
sending a trigger frame to a second communication apparatus, wherein the trigger frame comprises first information, the first information indicates the second communication apparatus to feed back at least one segment of a beamforming report, the at least one segment comprises a first segment, and the beamforming report is used to report channel information between the first communication apparatus and the second communication apparatus; and
receiving a beamforming report frame from the second communication apparatus, wherein the beamforming report frame comprises the first segment, the first segment indicates channel information on at least two subcarriers, a space between locations of indexes of any two of the at least two subcarriers in indexes of reference subcarriers is a multiple of N, the reference subcarriers are obtained based on bandwidth information, partial bandwidth information, and grouping information, and N is an integer greater than or equal to 2.

8. The apparatus according to claim 7, wherein the first information comprises M bits, each of the M bits corresponds to a segment of the beamforming report, a value of each bit indicates whether to feed back the corresponding segment, and M is an integer greater than or equal to 2.

9. The apparatus according to claim 7, wherein the indexes of the reference subcarriers in ascending order of frequencies are scidx(0), scidx(1), . . . , and scidx(Ns−1), wherein Ns is a total quantity of subcarriers comprised in the reference subcarriers, and Ns and the indexes of the reference subcarriers are obtained based on the bandwidth information, the partial bandwidth information, and the grouping information; and
an index of an i^{th} subcarrier in the first segment is scidx(k+N×i), wherein k indicates that the first segment is a k^{th} segment of the beamforming report, k is an integer greater than or equal to 0 and less than or equal to M−1, i is an integer greater than or equal to 0, and M is an integer greater than or equal to 2.

10. The apparatus according to claim 7, wherein N is a predefined integer, or Nis negotiated by the first communication apparatus and the second communication apparatus, or N is notified by the first communication apparatus to the second communication apparatus.

11. The apparatus according to claim 7, wherein the at least one processor further configured to generate a beamforming matrix based on the beamforming report frame, wherein the beamforming matrix is used to adjust an amplitude and/or a phase of a to-be-sent signal.

12. The apparatus according to claim 7, wherein
the at least one processor is further configured to send a null data packet announcement (NDPA) frame to the second communication apparatus, wherein the NDPA frame comprises the bandwidth information, the partial bandwidth information, and the grouping information, the bandwidth information indicates bandwidth of a channel measurement reference signal, the partial bandwidth information indicates a frequency segment in which the at least two subcarriers are located, and the grouping information indicates that channel information of one subcarrier in every Ng subcarriers is fed back; and
the at least one processor is further configured to send a null data packet (NDP) frame to the second communication apparatus, wherein the NDP frame is used for channel estimation.

13. A second communication apparatus, wherein the apparatus comprises at least one processor, the at least one processor configured to implement a method, comprising:
receiving a trigger frame from a first communication apparatus, wherein the trigger frame comprises first information, the first information indicates the second communication apparatus to feed back at least one segment of a beamforming report, the at least one segment comprises a first segment, and the beamforming report is used to report channel information between the first communication apparatus and the second communication apparatus; and
sending a beamforming report frame to the first communication apparatus, wherein the beamforming report frame comprises the first segment, the first segment indicates channel information on at least two subcarriers, a space between locations of indexes of any two of the at least two subcarriers in indexes of reference subcarriers is a multiple of N, the reference subcarriers are obtained based on bandwidth information, partial bandwidth information, and grouping information, and N is an integer greater than or equal to 2.

14. The apparatus according to claim 13, wherein the first information comprises M bits, each of the M bits corresponds to a segment of the beamforming report, a value of each bit indicates whether to feed back the corresponding segment, and M is an integer greater than or equal to 2.

15. The apparatus according to claim 13, wherein N is a predefined integer, or Nis negotiated by the first communication apparatus and the second communication apparatus, or N is notified by the first communication apparatus to the second communication apparatus.

16. The apparatus according to claim 13, wherein the beamforming report frame is used to determine a beamforming matrix, and the beamforming matrix is used to adjust an amplitude and/or a phase of a signal sent by the first communication apparatus.

17. The apparatus according to claim 13, wherein
the at least one processor is further configured to receive a null data packet announcement NDPA frame from the first communication apparatus, wherein the NDPA frame comprises the bandwidth information, the partial bandwidth information, and the grouping information, the bandwidth information indicates bandwidth of a channel measurement reference signal, the partial bandwidth information indicates a frequency segment in which the at least two subcarriers are located, and the grouping information indicates that channel information of one subcarrier in every Ng subcarriers is fed back; and
the at least one processor is further configured to receive a null data packet (NDP) frame from the first communication apparatus, wherein the NDP frame is used for channel estimation.
